(19) United States
(12) Patent Application Publication
(10) Pub. No.: US 2025/0067900 A1
(43) Pub. Date: Feb. 27, 2025

(54) WIND ESTIMATION FOR AIRCRAFT

(71) Applicants: Marc Damon Compere, Orlando, FL (US); Avinash Muthu Krishnan, Daytona Beach, FL (US); Kevin Allan Adkins, Longwood, FL (US)

(72) Inventors: Marc Damon Compere, Orlando, FL (US); Avinash Muthu Krishnan, Daytona Beach, FL (US); Kevin Allan Adkins, Longwood, FL (US)

(21) Appl. No.: 18/814,198

(22) Filed: Aug. 23, 2024

Related U.S. Application Data
(60) Provisional application No. 63/578,856, filed on Aug. 25, 2023.

(51) Int. Cl. G01W 1/08; B64U 10/13; B64U 101/35

(52) U.S. Cl. CPC G01W 1/08; B64U 10/13; B64U 2101/35

(57) ABSTRACT

Systems and techniques for wind estimation are presented herein, such as using Uncrewed Aircraft (UA). No on-board flow sensor is required, and the present subject matter does not require estimation of thrust or drag forces. For example, using only GPS (or another indicium of groundspeed) and orientation sensors, wind vectors in the Earth-fixed frame can be estimated during turning maneuvers. The “Wind-Arc” technique described herein was verified using simulation. Also, when applied to experimental flight test data, the technique works and follows both airspeed and wind speed trends.

### CLAIM OF PRIORITY

This patent application claims the benefit of priority of Compere et al., U.S. Provisional Patent Application No. 63/578,826, titled “WIND ESTIMATION FOR AIRCRAFT,” filed on Aug. 23, 2023 (Attorney Docket No. 4568.019PRV), which is hereby incorporated by reference herein in its entirety.

### FIELD OF THE DISCLOSURE

This document pertains generally, but not by way of limitation, to wind estimation, and more particularly to estimation of wind affecting an aircraft without requiring an on-board flow sensor or estimation of thrust or drag forces.

### BACKGROUND

Small uncrewed aircraft systems (SUAS) are providing access to the lower atmosphere in ways that have never before been possible. The prevalence and ease with which the lower atmosphere is accessible is revolutionizing aviation, weather observation, and atmospheric science. Colloquially referred to as drones, these small Uncrewed Aircraft (UA) are attractive across a broad range of applications including the next generation of aviation, weather forecasting, atmospheric science, agriculture, medical transport, emergency response, law enforcement, surveillance, mapping and remote sensing for mining, archaeology, forestry, package delivery, and sustainable smart cities, as illustrative examples. The usefulness of UA is clear, but associated regulations and procedures are still evolving. The FAA's and NASA's work on both Uncrewed Traffic Management (UTM) and Advanced Air Mobility (AAM) is evidence of the future potential and challenges involved. To develop new regulations and procedures, the FAA must ensure safe flight enroute and near vertiports, buildings, bridges, and other critical infrastructure. This is true for the current National Airspace (NAS) but also true for air volumes near critical infrastructure that are added to the NAS. Wind plays a role in flight around critical infrastructure, but wind is often (a) not measured and (b) more dynamic in these areas than in typical, open airspace. Seasonal and diurnal (time-of-day) variations around complex urban landscapes are difficult to predict. Additionally, small UA and future crewed aircraft will have less mass than most conventional aircraft. UA and AAM aircraft are more susceptible to wind and the environment in their intended flight locations. A lack of wind estimation in areas near infrastructure represents a safety risk to both UTM and AAM, and a technology gap for both UTM and AAM.

### SUMMARY OF THE DISCLOSURE

The present inventors have recognized, among other things, that there are no low-cost, scalable methods for estimating wind in urban areas around buildings, bridges, trees, towers, and power lines. Accordingly, the present inventors have recognized a need for a broadly applicable, cost effective, and scalable method for wind estimation such as for use by Uncrewed Aircraft. Uncrewed Aircraft (UA) can initially be flown in new, unexplored air volumes near infrastructure with greater safety for people and property than crewed aircraft. For example, UA may be the first air mobility presence in unchartered airspace to profile air volumes in preparation for greater use in the National Airspace.

Systems and techniques for wind estimation are presented herein, such as for use with Uncrewed Aircraft (UA). The present subject matter may assist in meeting the needs mentioned above and may be applicable to other applications as shown and described herein. No on-board flow sensor is required, and the present subject matter does not require estimation of thrust or drag forces. For example, using only GPS and orientation sensors, wind vectors in the Earth-fixed frame can be estimated during turning maneuvers. The “Wind-Arc” technique described herein was verified using simulation and experimental flight testing. In particular, when applied to experimental flight test data, the “Wind-Arc” technique works and follows both airspeed and wind speed trends.

In an example, a machine-implemented method can be used to perform a wind estimation technique, comprising receiving heading data and velocity data corresponding to two different samples associated with an aircraft in flight and determining a wind vector using a vector difference between the velocity data corresponding to the two different samples and the heading data. The resulting wind vector can be stored or transmitted.

In an example, a system can be used to perform a wind estimation technique, the system comprising at least one processor circuit, and at least one memory circuit coupled to the processor circuit, the memory circuit comprising instructions that cause the at least one processor circuit to instantiate a wind estimator, the instructions including receiving heading data and velocity data corresponding to two different samples associated with an aircraft in flight, determining a wind vector using a vector difference between the velocity data corresponding to the two different samples and the heading data, and storing or transmitting the determined wind vector.

In an example, the aircraft comprises and uncrewed aircraft. In an example, the determined wind vector (or a series of such determinations) can be used to control the aircraft. In an example, wind field data can be compiled corresponding to a series of wind vector determinations corresponding to different spatial locations of the aircraft.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a system that can implement or use a wind estimation technique as shown and described herein.

FIG. 2A, FIG. 2B, and FIG. 2C illustrate various wind estimation strategies.

FIG. 3A, FIG. 3B, and FIG. 3C illustrate different “wind triangles” according to the present subject matter, with FIG. 3C showing the wind triangles of FIG. 3A and FIG. 3B super-imposed on each other.

FIG. 4 illustrates generally two different airspeed vectors corresponding to two different headings in an NED frame.

FIG. 5A illustrates generally an earth-fixed locally tangent NED coordinate frame.

FIG. 5B illustrates generally an XYZ frame and NED frame.

FIG. 6 illustrates generally a technique for determining position in a vehicle dynamics simulation context.

FIG. 7 illustrates generally a technique for determining position using a vector derived from a wind triangle, with an output position vector in NED frame.

FIG. 8A shows an illustrative example comprising kinematic simulation of a Dubins' Airplane vehicle model with no wind, t_{final}=8 s.

FIG. 8B shows an illustrative example comprising kinematic simulation of a Dubins' Airplane vehicle model with \vec{W}=[5 1] (m/s) for 24 s.

FIG. 9 shows an illustrative example comprising a three-dimensional representation of the kinematic simulation of FIG. 8B, showing Upward spiral results from wind vector, \vec{W}=[5 1] (m/s), and u_{z}=1.5 (m/s).

FIG. 10A and FIG. 10B shows simulated wind triangles computed with, in FIG. 10A, full information from the simulation; \vec{W}=[5 1] (m/s), and FIG. 10B, sensor-less estimation; \vec{W}=[5 1] (m/s).

FIG. 11 shows an illustrative example comprising kinematic simulation of a simulated flight trajectory with 1 m/s step change in wind X-component at t=5 s.

FIG. 12 shows an illustrative example comprising a comparison between idealized and estimated wind magnitudes, based on simulation, and showing an error associated with a step input at t=5 s.

FIG. 13 shows an illustrative example of wind triangles formed using kinematic simulation, with a simulated step input at t=5 s.

FIG. 14 shows an illustrative example of wind triangles formed by simulating a Wind-Arc technique as shown and described herein, with a simulated step input at t=5 s.

FIG. 15 illustrates magnitude and angle of the wind triangles of FIG. 13, showing at t=5 s, a malformed wind triangle.

FIG. 16 shows a flight path associated with experimentally-obtained flight trajectory data, where the flight path has been segmented.

FIG. 17 shows an illustrative example of wind triangles formed by processing the flight trajectory segments shown in FIG. 16.

FIG. 18 shows an illustrative example of a more detailed view of a portion of FIG. 17 including segments defined by a zig-zag pattern.

FIG. 19 shows an illustrative example of another detailed view of a portion of FIG. 17 including segments defining loiter circles.

FIG. 20 shows a comparison between measured airspeed and Wind-Arc estimated airspeed.

FIG. 21 shows a comparison between anemometer-derived wind speed with vehicle velocity subtracted and Wind-Arc estimated airspeed.

FIG. 22A and FIG. 22B show computed differences between flow-sensor-based measurements and Wind-Arc estimated speeds, with airspeed differences shown in FIG. 22A and wind speed differences shown in FIG. 22B.

FIG. 23 shows a flight path associated with experimentally-obtained flight trajectory data comprising 65 seconds of constant-yaw-rate turning.

FIG. 24 shows yaw, pitch, and roll parameters corresponding to the 65 s flight trajectory shown in FIG. 23 and performed using manual pilot input.

FIG. 25 shows wind triangles determined using a Wind-Arc technique between spiral 2 and spiral 3 of the flight path shown in FIG. 23.

FIG. 26 shows a comparison between anemometer-derived airspeed and Wind-Arc estimated airspeed corresponding to the portion of the flight path shown in FIG. 25.

FIG. 27 shows a comparison between anemometer-derived wind speed and Wind-Arc estimated wind speed corresponding to the flight path shown in FIG. 23.

FIG. 28A and FIG. 28B show computed differences between flow-sensor-based measurements and Wind-Arc estimated speeds, with airspeed differences shown in FIG. 28A and wind speed differences shown in FIG. 28B, corresponding to the flight path shown in FIG. 23.

FIG. 29 illustrates generally a technique, such as a machine-implemented method, for performing the Wind-Arc technique shown and described herein.

FIG. 30 illustrates a block diagram of an example comprising a machine upon which any one or more of the techniques (e.g., methodologies) discussed herein may be performed.

### DETAILED DESCRIPTION

A variety of different approaches can be used to perform wind velocity measurements. Generally, the aviation community is interested in only as much accuracy as needed to safely fly aircraft. Measuring the direction and approximate magnitude are sufficient. An aviator's approach can be as simple as dropping blades of grass at an airfield to see which way they fall or how fast they fall. Where a wind-sock is available, aviators are trained to estimate the prevailing wind speed and direction using a wind-sock, anemometers are referenced from ground-based weather stations which can, sometimes, be an appreciable distance away. These readings are helpful but sometimes not sited close enough to the flight area to be useful. This is one motivation for hyper-local wind estimation. Pitot tubes are the most common method for estimating airspeed while in flight. A method used by early aviators is called ‘the circle’ or ‘wind drift circle’ or the ‘turns around’ method to estimate wind and direction. The weather community uses anemometers for stationary measurements at weather stations or meteorological towers.

Newer weather stations typically use sonic anemometers, whereas earlier stations used cup-type. Meteorological towers and wind LiDAR are both designed to provide vertical wind profiles. The tower requires more infrastructure than a ground-based wind LIDAR but often provides superior measurements. Wind farm profiling, rocket launches, and profiling winds near buildings and bridges are use-cases that need this type of wind monitoring. In NASA flight tests, a smoke tower was used to visualize turbulent vortices generated by a passing aircraft. These studies helped inform FAA take-off spacing times. Mobile wind measurements for weather prediction also include dropping radiosondes or launching weather balloons. The atmospheric science community uses all of these methods but typically rely on 2D or 3D sonic anemometers. Engineers and scientists can use multi-hole pressure probes (MHPPs), hot-wire anemometry Particle Image Velocimetry (PIV), or Particle Tracking Velocimetry, depending on the application. Engineers and aerodynamicists in the aviation and race car communities use CFD simulations, smoke-streams in wind tunnels, or tufts of yarn attached to a wing or an airfoil. The most accurate used by the National Institute for Standards and Technology (NIST) is called a Laser Doppler Anemometer (LDA). In 2010, NIST replaced Pitot tubes with Laser Doppler Anemometers because Pitot tubes require air properties while LDA measurements are entirely mechanical, and thus traceable to the U.S. National standards of length and time. LDA can measure flows as slow as blood movement in blood vessels and as high as rocket exhaust velocities nearing 1000 m/s.

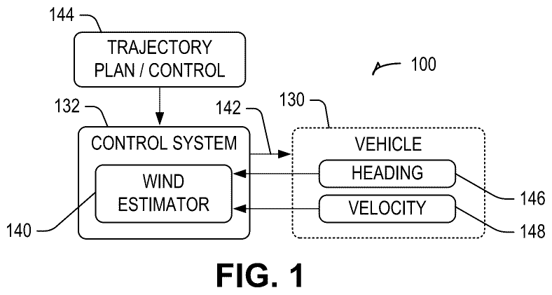

FIG. 1 illustrates generally a system 100 that can implement or use a wind estimation technique as shown and described herein. The architecture of the system 100 can be implemented as an embedded control system such as located on or within a vehicle 130 such as an aircraft. Such an architecture can include one or more processor circuits or other execution units such as coupled with one or more associated memory circuits, or the techniques described herein can be implemented in one or more application-specific or field-programmable circuits such as an Application Specific Integrated Circuit or Field Programmable Gate Array. Such circuitry can include general purpose processor circuitry or vector compute circuitry such as formed using one or more Graphics Processor Units (GPUs). The system 100 can receive, include, use, store, or generate a trajectory plan 144 or other control input, such as provided to a vehicle (e.g., flight) control system 132. The trajectory plan can include a mission profile (e.g., a two-dimensional or three-dimensional representation of an intended trajectory) or can represent commanded trajectory inputs such as directional changes, altitude changes, or the like. Generally, the control system 132 provides commands represented in control data 142 or signals to actuate control elements of the vehicle 130, such as flight control surfaces, rotor speeds, or other elements, as illustrative examples. The control system 132 can form a closed-loop structure, such as receiving sensed information from one or more sensors located on or within the vehicle 130. Data representative of the one or more sensors can be provided to a wind estimator 140. For example, the wind estimator 140 can receive data indicative of heading 146 and velocity 148, such as derived from other sensors (e.g., from an inertial sensor or Global Navigation Satellite System such as Global Position System (GPS)). As shown and described herein, the heading and velocity information can be used to perform estimation of wind speed (such as indicated by a magnitude and a direction of wind referred to a specified coordinate frame). The approaches described in this document do not require an anemometer or flow-sensor on-board the vehicle 130. The vehicle 130 can include an Uncrewed Aircraft (UA) such as fixed-wing or multi-rotor drone, as illustrative examples.

### Approach 1: Direct Flow Measurement Using On-Board Flow Sensors

By mounting an air flow measurement device on an Uncrewed Aircraft, the vehicle's airspeed can be estimated directly. This is a direct flow measurement in the body-fixed vehicle frame. Direct flow measurement can be performed using any sensor that is compact and light enough to fit the aircraft's payload capacity. There are several on-board flow sensor options, but, in practice, only two types are commonly seen on UA: pressure sensors and sonic anemometers.

### Pressure-Based Pitot Tubes or MHPPs

Pressure-based flow sensors measure static and total air flow pressure and directly relate it to speed. Single-hole Pitot tubes produce a one-dimensional wind measurement along the axis of the tube. MHPPs use the same concept but, with additional holes, are able to produce 2D or 3D wind vector measurements. Pressure flow sensors, however, can only measure the sensor's facing direction. This concept is well suited for fixed-wing aircraft, but multi-rotors have more complex six-degree-of-freedom motion. The ability for omnidirectional motion, plus associated rotor wash, makes it difficult to incorporate a directional-based sensor like a Pitot tube or MHPP on a multi-rotor UA.

### Ultrasonic Anemometers

Two examples of ultrasonic flow sensors include: Time-of-Flight (Tof) and Acoustic Resonance. Time-of-flight sensors relate wind speed to the measured duration for an ultrasonic pulse to travel from an emitter to a receiver. The air flow influences pulse speed, and both 2D and 3D correlations are effectively achieved using sonic anemometers. The second sensor type, used in obtaining experimental data for evaluation of the present subject matter, is an Acoustic Resonance (Acu-Res®) FT205 to measure wind speed and direction independent of air temperature and pressure. Ultrasonic anemometers can be used, for example, on multi-rotor UA. Mounting these sensors on fixed-wing UA sometimes adds complications by changing the vehicle's center of gravity and flight characteristics, along with the consideration given to sensor placement. Pressure-based or ultrasonic sensors can arrive pre-calibrated from the factory. Neither has any moving parts, but there is a cost penalty associated with high-quality anemometers. Prices range from USD 1500 to over USD 20,000 at the time of this filing, and any calibration adds to the operational complexity and cost.

### Mounting and Flight Considerations

A challenge with the flow sensor method is ensuring that the sensor is sufficiently far enough away from the rotor-induced flow field to measure representative ambient air. Also, sensor mounting needs to include power and a signal for data logging. The on-board sensors measure airspeed. To measure wind, vehicle velocity is generally subtracted. The wind triangle relationships presented later in this document use an Earth-fixed frame, such as North-East-Down (NED). Since measurements are in the body-fixed frame, the transformation from the body-fixed frame to the NED frame uses vehicle orientation data, which is another three or four floating point numbers. Accordingly, subtracting vehicle speed from the airspeed measurement seems conceptually straightforward but is generally difficult in practice. In addition to this challenge, the incorporation of any specialized mechanical or electrical sensor involves additional pre-flight attention, and (assuming an electrical energy source for propulsion) the sensor payload will either reduce power from the vehicle's mobility battery directly or require additional payload for an instrumentation battery. It may be possible to incorporate data collection into a flight controller separately, but this has been generally avoided in the examples herein to avoid a possibility of interfering with UA command and control (C2).

Approach 2: Thrust and Drag Force Estimation while Rejecting Wind A second wind estimation approach can rely on estimating vehicle thrust and drag forces during some type of prescribed flight path. If the vehicle is stationary (hovering), such as with multi-rotors, this method can be referred to as a “tilt angle” or “tilt” method. The assumption is that the on-board flight controller will reject wind disturbances effectively. The compensation involved to reject these disturbances can be related to the magnitude and direction of wind acting on the UA. For example, DJI (Miami, Florida, USA) multi-rotor flight controllers can provide wind speed estimates during flight, over the flight telemetry channel. This is helpful, but the wind estimation accuracy and method are both unknown because DJI controllers generally use a proprietary, closed-source ecosystem.

### Classical Dynamics Modeling Approach

Some methods estimate thrust and drag forces by leveraging the sophisticated on-board flight controllers with high-speed feedback loops and hard real-time operating systems. With known thrust and drag force estimates, and the vehicle's windward frontal area, the wind direction and velocity can be estimated. Such methods include approaches to characterize motor and rotor thrust and to monitor the flight controller response signals, and can estimate mass distribution on-board, in real time.

### Machine Learning Method

Certain quantities in the classical dynamics modeling approach are hard to measure and obtain. Examples include controller-specific gains used to reject wind disturbances, rotor speeds for a thrust measurement, and the wind-facing frontal area and drag coefficients. Machine Learning (ML) approaches have seen an increase in popularity, specifically for estimating these difficult quantities. A drawback of this form of estimation can lie with the generated ML model. Such models are generally very specific to the trained vehicle and are not effectively usable across a variety of different platforms. These strategies are also not generally used for real-time predictions.

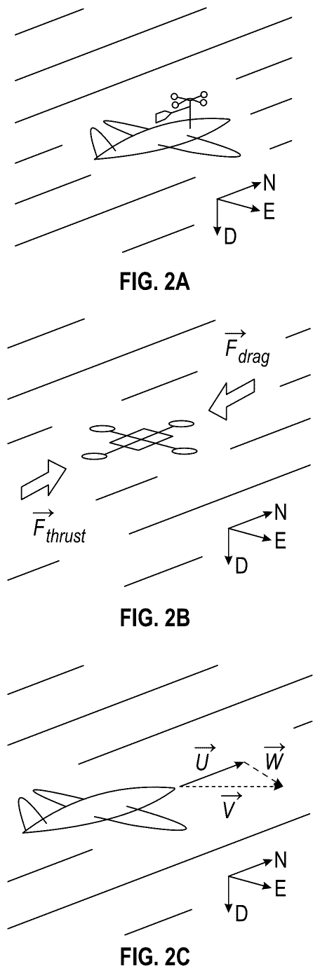

FIG. 2A, FIG. 2B, and FIG. 2C illustrate various wind estimation strategies, with Approach 1, discussed above, shown in FIG. 2A, and Approach 2, discussed above, shown in FIG. 2B. A new approach according to the present subject matter is shown and described below, and associated vectors are illustrated generally in FIG. 2C.

### Wind-Arc Technique

Approach 1 described above needs on-board flow sensors. Approach 2 estimates thrust and drag force while the flight controller rejects wind as a disturbance. The Wind-Arc technique (e.g., a machine-implemented method) described in this document does not require (and need not use) a flow sensor and has an entirely different basis than Approach 2. Instead of rejecting wind as a disturbance, this method seeks uses influence from the wind. In comparison to an aviator's wind drift circle method, the present technique does not require an entire circle to be flown. The approach described herein can be referred to as a “Wind-Arc” technique because it can use an abbreviated or fractional version of a wind drift circle. Because it functions while turning but does not require a complete circle, it is a fractional circle, or arc. The technique described herein can be subject to applied constraints, such as a constraint that a vehicle airspeed remains constant and a constraint that a wind speed remain constant between the two sensor samples (e.g., “snapshots” at t₁ and t₂). Small vehicle heading changes, ψ₁ and ψ₂, can be combined with GPS or other GNSS-obtained velocity vectors, \vec{v}₁ and \vec{v}₂, at the two sampled headings. Using these, plus a constant wind assumption, the 2D or 3D wind vector, W, can be solved algebraically.

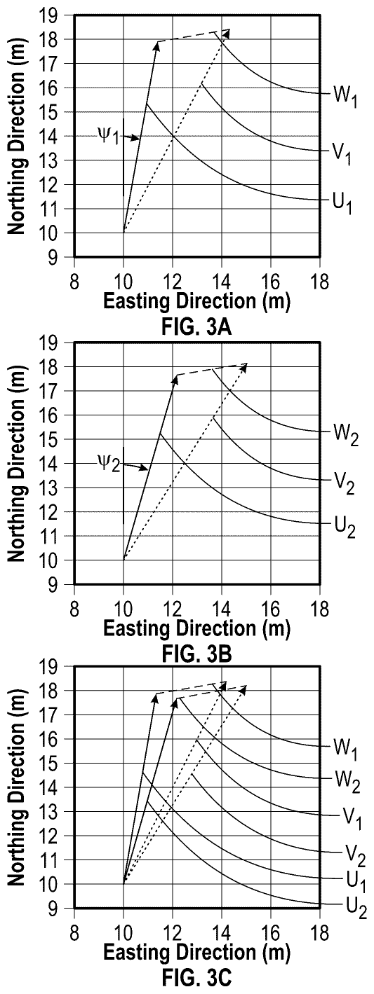

FIG. 3A, FIG. 3B, and FIG. 3C illustrate different “wind triangles” according to the present subject matter, with FIG. 3C showing the wind triangles of FIG. 3A and FIG. 3B super-imposed on each other. The Wind-Arc technique can use wind triangles corresponding to two different samples (e.g., at two separate instances) to algebraically solve for a wind vector, such as using constant wind and constant airspeed assumptions. A wind triangle is defined as a vector relationship between vehicle ground speed, airspeed, and wind vectors:

$$\vec{V} = \vec{U} + \vec{W} \qquad ( 1 )$$

where \vec{V} is the vehicle's ground speed vector, \vec{U} is the vehicle′ airspeed vector, and \vec{W} is the wind speed vector. Herein, vectors are expressed in Earth-fixed North-East-Down (NED) coordinates. Also, the wind triangle and this formulation are valid for 3D vectors, but only 2D vectors are presented for clarity. For an aircraft maneuvering from heading 1 to heading 2, the wind triangle is illustrated in FIG. 3A, FIG. 3B, and FIG. 3C. The airspeed vectors \vec{U}₁ and \vec{U}₂ are identical in magnitude between FIG. 3A and FIG. 3B, but are rotated by a small angle, Δψ, from ψ₁ to ψ₂. The wind vectors \vec{W}₁ and \vec{W}₂ are identical in FIG. 3A and FIG. 3B. The heading change is defined in equation (2) which represents the orientation change.

$$Δ ψ = {ψ}_{2} - {ψ}_{1} \qquad ( 2 )$$

The wind triangles shown in FIG. 3A and FIG. 3B capture this heading change. For states 1 and 2, the wind triangle relationships are both true at each instant, and thus, represent two independent equations:

$${\vec{V}}_{1} = {\vec{U}}_{1} + {\vec{W}}_{1} \qquad ( 3 )$$

$${\vec{V}}_{2} = {\vec{U}}_{2} + {\vec{W}}_{2} \qquad ( 4 )$$

The ground speed vectors \vec{V}₁ and \vec{V}₂ are directly measurable, such as by GPS. The airspeed vectors \vec{U}₁ and \vec{U}₂ and wind vectors \vec{W}₁ and \vec{W}₂ are generally unknown. By comparing successive measurements between heading angles ψ₁ and ψ₂, and assuming the airspeed magnitude and wind vectors remain constant during this brief period, the wind triangles in Equations (3) and (4) represent two independent equations, which allows for a solution of both \vec{U} and \vec{W} at instants 1 and 2. The assumptions for constant airspeed and wind speed can be represented by the following constraints:

$$\vert {\vec{U}}_{1} \vert = \vert {\vec{U}}_{2} \vert \qquad ( 5 )$$

$${\vec{W}}_{1} = {\vec{W}}_{2} \qquad ( 6 )$$

Rearranging (3) and (4) to express \vec{W}₁ and \vec{W}₂ explicitly in the NED frame gives the following:

$${\vec{W}}_{1} = {\vec{V}}_{1} - {\vec{U}}_{1} \qquad ( 7 )$$

$${\vec{W}}_{2} = {\vec{V}}_{2} - {\vec{U}}_{2} \qquad ( 8 )$$

Assuming the wind is constant during the short period between points 1 and 2, this allows the wind vectors to be solved algebraically. Relating (7) and (8) with (6) results in the following:

$${\vec{V}}_{1} - {\vec{U}}_{1} = {\vec{V}}_{2} - {\vec{U}}_{2} \qquad ( 9 )$$

These vector relationships are in the Earth-fixed NED frame and \vec{V}₁ and \vec{V}₂ are measurable using GPS. Accordingly, what is then used is a relation between two airspeed vectors between points 1 and 2.

### Alias and Alibi Transformations

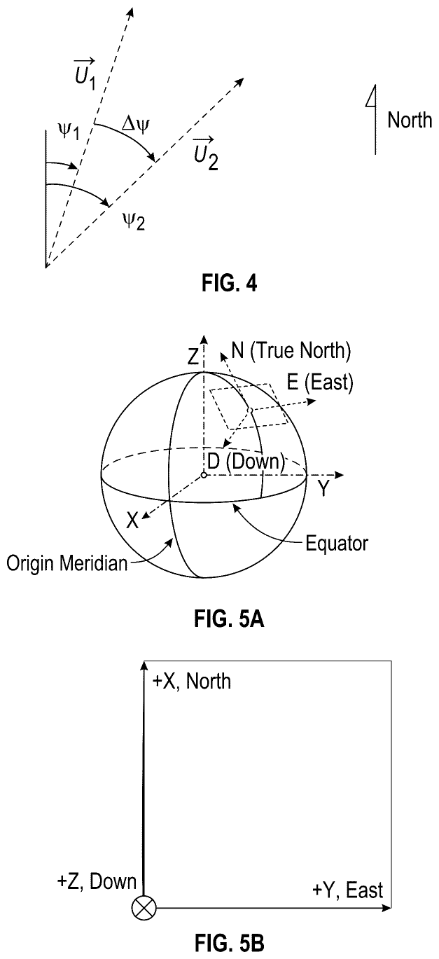

FIG. 4 illustrates generally two different airspeed vectors corresponding to two different headings in an NED frame. There are two unknown airspeed vectors in Equation (9): \vec{U}₁ and \vec{U}₂. Equation (5) states that the magnitudes of these airspeed vectors are approximately the same, but their directions can be different because the vehicle turns from heading 1 to heading 2. This may seem a straightforward application of a 2×2 transformation matrix. But there is a subtle difference that facilitates arriving at a correct solution. In robotics and dynamics, a vector can be transformed to a new or different coordinate frame. This is called a passive or alias transformation. This is illustrated with the unit vector i and j components of frames 1 and 2:

$$\begin{matrix}[ \begin{matrix}{\hat{l}}_{2} \\ {\hat{J}}_{2}\end{matrix} ] = {T}_{Δ} \cdot [ \begin{matrix}{\hat{l}}_{1} \\ {\hat{J}}_{1}\end{matrix} ] & where & {T}_{Δ} = [ \begin{matrix}c Δψ & s Δψ \\ - s Δ ψ & c Δψ\end{matrix} ]\end{matrix} \qquad ( 10 )$$

What is used to solve Equation (9) is an active or alibi transformation, because \vec{U}₂ represents a different vector in the same NED coordinate frame. Using identical terminology as in (10) illustrates the difference:

$$\begin{matrix}[ \begin{matrix}{\hat{l}}_{2} \\ {\hat{J}}_{2}\end{matrix} ] = {T}_{Δ}^{T} \cdot [ \begin{matrix}{\hat{l}}_{1} \\ {\hat{J}}_{1}\end{matrix} ] & where & {T}_{Δ} is defined above\end{matrix} \qquad ( 11 )$$

The difference between Equations (9) and (10) is the transpose operator. Now, \vec{U}₂ can be expressed as a function of \vec{U}₁ and the small heading change, Av, with the alibi transformation:

$${\vec{U}}_{2} = {T}_{Δ}^{T} \cdot {\vec{U}}_{1} \qquad ( 12 )$$

Inserting (12) into (9) and rearranging yields the airspeed vector, \vec{U}₁, as a function of GPS velocities at points 1 and 2 and the orientation change, Av:

$${\vec{U}}_{1} = {N}^{- 1} \cdot [ {\vec{V}}_{2} - {\vec{V}}_{1} ] \qquad ( 13 )$$

where N=T_{Δ}^{T}−I and I is the 2×2 identity matrix. Equation (13) estimates the airspeed using only ground velocity vectors from two GPS samples and the associated heading angles, which are obtainable from an orientation sensor. The only two constraints incorporated in this analytical treatment are constant airspeed magnitude and constant wind vectors between samples 1 and 2. A related constraint is that a change in heading angle is large enough to ensure matrix N has a well-conditioned inverse. The inverse of N will exist for all |Δψ|>Δψₜₕᵣₑₛₕ. As an illustration, use of a threshold, Δψₜₕᵣₑₛₕ, between 1 and 10 degrees provides a well-conditioned inverse for N, even with real sensors and associated errors. The heading angle change can be larger than 10 degrees, but this risks more sensor snapshots between points 1 and 2 that violate the constant wind and airspeed assumptions compared to a smaller angle change threshold. So, a lower bound can be used, assuming N⁻¹ is well conditioned. As an illustration, a sample can be triggered in response to a heading change within a specified range, such as exceeding the threshold. Capturing wind estimates as quickly as reasonable also provides a higher frequency of estimates that can help deduce true wind speed despite non-constant winds (i.e., invalid assumptions) during some 1-2 snapshots.

With the airspeed \vec{U}₁ known, and \vec{U}₂ from (12), the wind vectors can be solved algebraically. Inserting (13) into (7) yields:

$${\vec{W}}_{1} = {\vec{V}}_{1} - {N}^{- 1} \cdot [ {\vec{V}}_{2} - {\vec{V}}_{1} ] \qquad ( 14 )$$

and inserting (12) and (13) into (8) yields:

$${\vec{W}}_{2} = {\vec{V}}_{2} - {T}_{Δ}^{T} \cdot {N}^{- 1} \cdot [ {\vec{V}}_{2} - {\vec{V}}_{1} ] \qquad ( 15 )$$

Common GPS receivers provide speed and Course Over Ground (COG) directions, both of which are scalars. The \vec{V}₁ and \vec{V}₂ vectors can be assembled from GPS speed and COG using:

$$\vec{V} = [ \begin{matrix}GPS speed \cdot cos ( COG ) \cdot \hat{I} \\ GPS speed \cdot sin ( COG ) \cdot \hat{J}\end{matrix} ] \qquad ( 16 )$$

GPS speed and COG may need to be converted into SI units. GPS speed is often reported in knots and Course Over Ground reported in degrees on [0, 360]. FIG. 5A illustrates generally an earth-fixed locally tangent NED coordinate frame and FIG. 5B illustrates generally an XYZ frame and NED frame. The Î and Ĵ vectors represent NED directions in the northing and easting directions, respectively, as shown in FIG. 5A and FIG. 5B. North corresponds to the +X axis and east corresponds to the +Y axis.

### Results in Simulation

Wind is unpredictable and rarely is constant for more than brief moments. Simulation can provide idealized wind vectors, or fields that are constant or change predictably to verify algorithm effectiveness in different scenarios. A simple kinematic vehicle model called the Dubins Airplane was used to model fixed-wing aircraft motion and turning. The kinematic model has no forces or moments and describes 3D motion given a forward velocity, V; vertical climb rate input, u_{z}; and roll angle, ¢, for turning. The model is similar to Dubins' Car but modified to model a fixed-wing aircraft. The kinematic equations of motion in the Earth-fixed, XYZ, frame can be represented as:

$${\vec{v}}_{g}^{X Y Z} = {[ \begin{matrix}V \cdot cos ( ψ ) \cdot cos ( γ ) \\ V \cdot sin ( ψ ) \cdot cos ( γ ) \\ {u}_{Z}\end{matrix} ]}^{XYZ} \qquad ( 17 )$$

Steering can be achieved by specifying a roll angle, ϕ, that generates the vehicle yaw rate:

$$\dot{ψ} = ( g / V ) \cdot tan ( ϕ ) \qquad ( 18 )$$

where g is gravity. The glide path angle is defined as γ=arctan (u_{z}/V).

### Coordinate Frames for Vehicle Dynamics and the Wind Triangle

Care is generally taken to keep track of different coordinate frames and terminologies among the dynamics, weather, aviation, and atmospheric science communities. Three coordinate frames are involved in simulation and the associated experimental data: Cartesian XYZ, NED, and Universal Transverse Mercator (UTM). To model vehicle motion in the presence of wind, the vehicle motion equations above use an additional term to create the previously established wind triangle, \vec{V}=\vec{U}+\vec{W}. The vector \vec{V} generally represents a ground speed measurable by GPS, \vec{U} is the airspeed, and \vec{W} is the wind speed. The vehicle's Cartesian coordinate frame, XYZ, is Earth-fixed, right-handed, and suitable for the wind triangle relationship. But the aviation, weather, and atmospheric science communities describe wind and the wind triangle in either the North-East-Down (NED) or the East-North-Up (ENU) frames. The NED frame is used, which is Earth-fixed, Cartesian, and locally tangent to Earth's surface. It is identical to the XYZ frame with the following mapping:

$$\begin{matrix}+ X corresponds to north \\ + Y corresponds to east \\ + Z is down , or into the ground\end{matrix} \qquad ( 19 )$$

As mentioned above, FIG. 5A and FIG. 5B illustrate the NED frame locally tangent to Earth's surface and also the explicit mapping from a Cartesian XYZ frame to the same NED frame, respectively. When converting geodetic latitude and longitude coordinates from a GPS unit, a suitable choice is conversion to Universal Transverse Mercator (UTM) coordinates. Assuming a WGS-84 Earth ellipsoid, these UTM coordinates are locally tangent, Cartesian, and a right-handed frame identical to the NED and the XYZ frames presented above. A fourth coordinate frame called Web Mercator is a widely accepted standard for displaying objects on maps using standard online software libraries. Web Mercator is used in this document only for map-based display purposes and is not involved in equation development.

### Computing Vehicle Position Using the Wind Triangle

First, a standard method for computing vehicle position is presented, and then, the adjusted method that includes influence from wind is presented.

Standard Method for Computing Vehicle Position without Wind

Computing position in simulation can be performed after modeling vehicle velocity. Newton-Euler dynamic models sum forces and moments in a body-fixed frame to achieve accelerations, and then, velocities in the body-fixed frame. Similarly, for kinematic models, vehicle motion can be specified in the body-fixed frame. Accordingly, for both dynamic and kinematic models, operations for computing position can include:
1. Transform the body-fixed velocity, \vec{v}_{g}^{xyz}, to velocity in the inertial or Earth-fixed frame, \vec{v}_{g}^{XYZ}
2. Integrate the Earth-fixed velocity, \vec{v}_{g}^{XYZ}, to achieve position in the Earth-fixed or NED frame:

$${\vec{r}}_{g}^{X Y Z} = \int {\vec{v}}_{g}^{X Y Z} \cdot dt \qquad ( 20 )$$

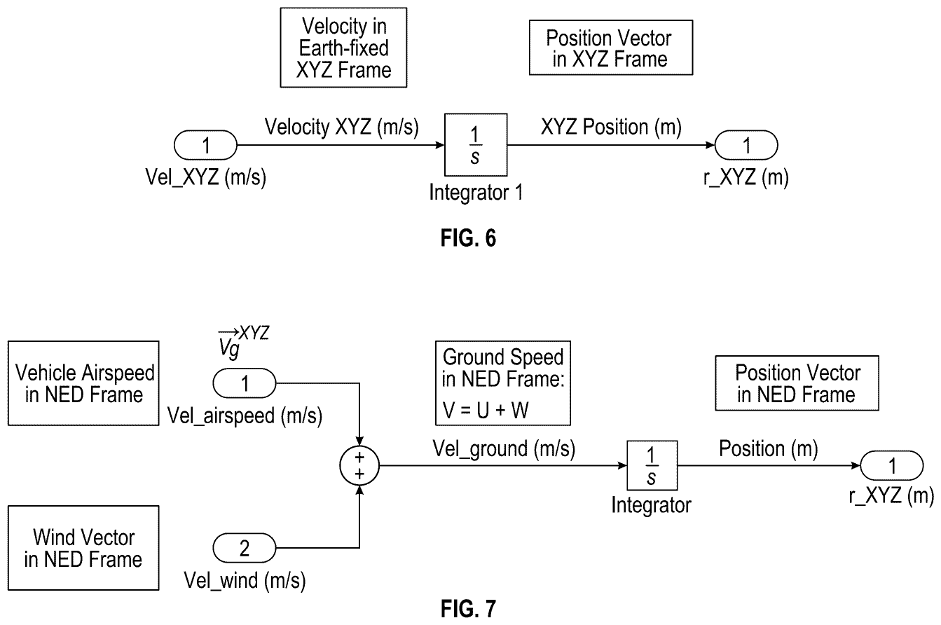

Integrating body-fixed velocity will not generate meaningful results because of the rotating XYZ frame. FIG. 6 illustrates generally a technique (e.g., implemented in Simulink) for determining position (e.g., to provide periodic position updates) in a vehicle dynamics simulation context. The result is a position vector, \vec{r}_{g}^{XYZ}, in the inertial XYZ frame.

Modeling Vehicle Position with Influence from Wind

FIG. 7 illustrates generally a technique for determining position using a vector derived from a wind triangle, with an output position vector in NED frame. To construct a wind triangle, the vehicle velocity in Earth-fixed coordinates, \vec{v}_{g}^{XYZ} is relabeled as the vehicle's airspeed, \vec{U}, which is in Earth-fixed coordinates (e.g., NED frame). Then, the wind triangle can be established using vector addition of airspeed, \vec{U}, and wind speed, \vec{W}, to create the new ground speed vector, \vec{V}. The modified operations for computing vehicle position with the influence of wind are summarized below:
1. Assign airspeed to vehicle velocity in the NED frame, or XYZ coordinates: \vec{U}=\vec{v}_{g}^{XYZ}
2. Add the wind vector, \vec{W}, to vehicle airspeed, creating the wind triangle relationship: \vec{V}=\vec{U}+\vec{W}
3. Integrate the new ground speed, \vec{V}, to achieve position in the Earth-fixed NED frame:

$${\vec{r}}_{g}^{XYZ} = \int \vec{V} \cdot dt \qquad ( 21 )$$

To verify this using a simple thought experiment, a wind speed vector of zeros can be considered. If \vec{W}=0, then \vec{V}=\vec{U}, which implies that airspeed is identical to ground speed when there is no wind.

Idealized \vec{U}, \vec{V}, and \vec{W} vectors are available for careful study and visualization during or after simulation. These relationships are valid for 2D or 3D vectors, and the wind can be modeled simply as a constant or a more complex model like a field that varies with space and time, \vec{W}=\vec{W}(t,X,Y,Z).

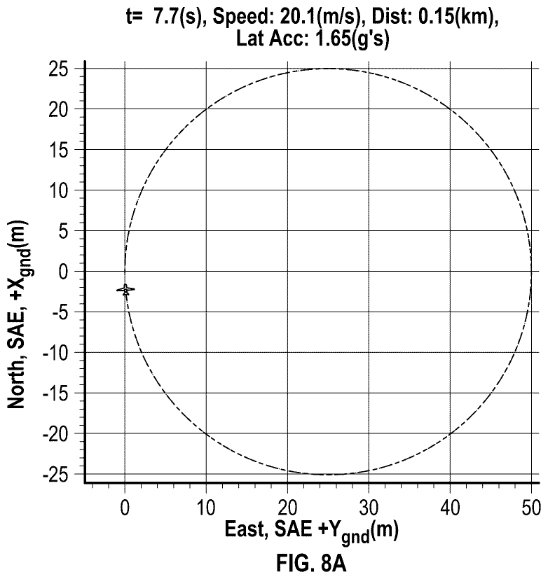

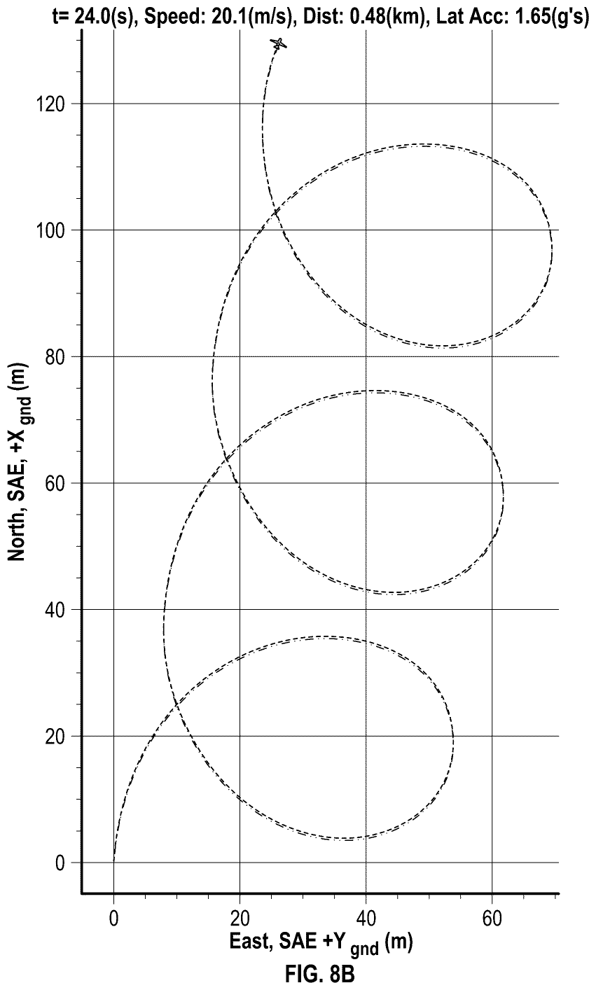

FIG. 8A shows an illustrative example comprising kinematic simulation of a Dubins' Airplane vehicle model with no wind, t_{final}=8 s and FIG. 8B shows an illustrative example comprising kinematic simulation of a Dubins' Airplane vehicle model with \vec{W}=[5 1] (m/s) for 24 s.

Simulation for Turning Motion with and without Wind

To illustrate the wind estimation technique described herein, a Dubins Aircraft kinematic model, plus the wind described above, and vehicle parameters for a medium-sized fixed-wing aircraft were simulated with a constant turning radius of 25 m. The simulation provides an environment in which to test wind estimation techniques under different wind conditions and verify both their viability and limitations. FIG. 8A illustrates the nominal flight path while turning with no wind. A constant radius is expected and shown. FIG. 8B illustrates the same steering inputs with wind with \vec{W}=[5 1] (m/s). The expected spiral pattern emerges with an average drift slope of 5:1 in the NED coordinate frame.

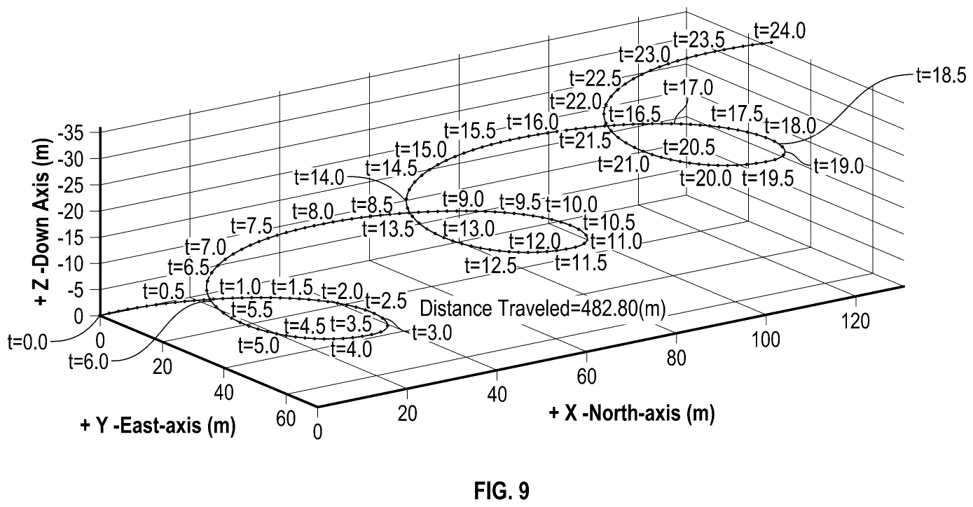

FIG. 9 shows an illustrative example comprising a three-dimensional representation of the kinematic simulation of FIG. 8B, showing Upward spiral results from wind vector, \vec{W}=[5 1] (m/s), and u_{z}=1.5 (m/s). The trajectories shown in FIG. 8A and FIG. 8B are corkscrew-style traces because a fairly aggressive climb rate of u_{z}=300 ft/min (1.5 m/s). FIG. 9 shows a 3D perspective of the same simulation. The simulation parameters used for the illustrations above are shown below in TABLE 1.

TABLE 1
Fixed-Wing Simulation Parameters

| Parameters | Value |
|---|---|
| Glide path angle, γ | 4.3° |
| Wingspan | 94 in. (2.4 m) |
| Length | 50 in (1.3 m) |
| Cruise velocity | 45 mph (21 m/s) |
| Elevation rate, u_{z} | 300 ft/min (1.5 m/s) |

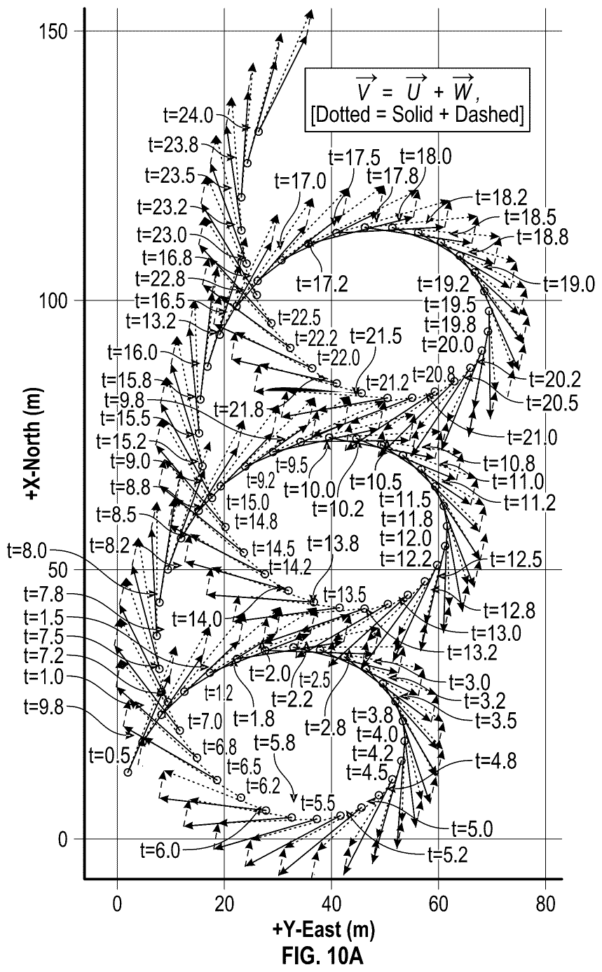

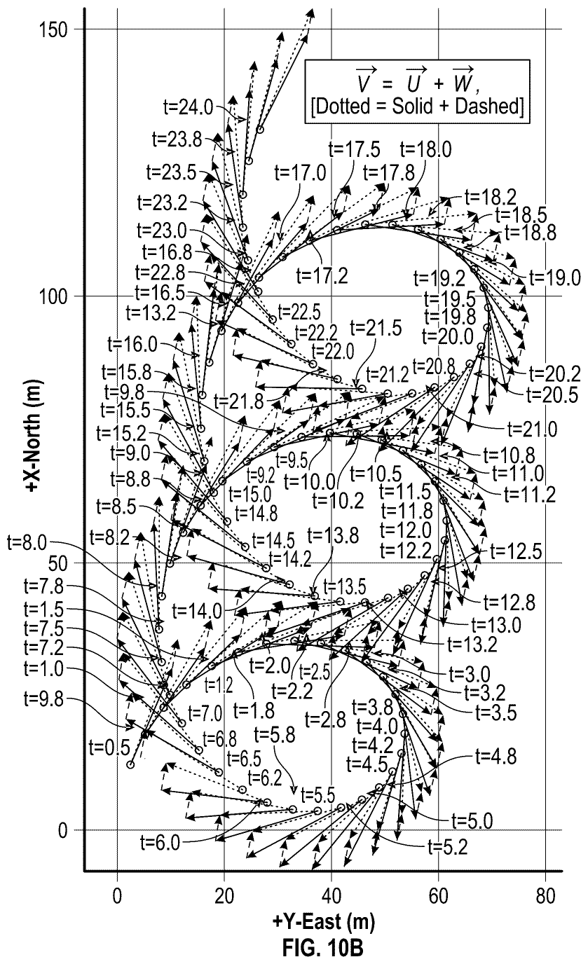

FIG. 10A and FIG. 10B shows simulated wind triangles computed with, in FIG. 10A, full information from the simulation; \vec{W}=[5 1] (m/s), and FIG. 10B, sensor-less estimation; \vec{W}=[5 1] (m/s).

Simulating Wind Triangles All three idealized wind triangle components are available explicitly in the simulation because ground speed, V, is created by adding the vehicle velocity vector, U, to the wind velocity vector, W. FIG. 10A shows the simulated, ideally formed wind triangles at multiple points along the same route from FIG. 8B. The Wind-Arc technique is also computed using Equations (12) to (16) and is shown in FIG. 10B for comparison with FIG. 10A. The estimated wind results in FIG. 10B are indistinguishable from the idealized \vec{U}, \vec{V}, and \vec{W} vectors obtained directly from simulation. This shows that the Wind-Arc wind estimation technique works as expected under simulated conditions when constant airspeed and wind assumptions (5) and (6) are met. The Wind-Arc estimation technique can be triggered or otherwise driven by state-based changes in vehicle heading, ψ. This can be implemented using a capture-and-hold function. When a current heading change from a previously captured heading exceeds a threshold, |Δψ|>Δψₜₕᵣₑₛₕ, another sensor snapshot can be captured, triggering the airspeed and wind vector estimates. The only two (simulated) sensors used for estimation of wind triangles in FIG. 10B are vehicle heading, ψ, and ground speed, \vec{V}, measurable with a compass and GPS, respectively, as illustrative examples.

Simulation Experiment 1: Wind Vector Step Input at t=5 s

FIG. 10B discussed above shows the Wind-Arc technique works under idealized steady wind conditions. During real flights, unknown wind variation will occur. The simulation can provide valuable clues to the method's capabilities and limitations under changing wind conditions. The next sequence of figures illustrates the same simulated trajectory as above, and a similar wind vector of \vec{W}=[5 1] (m/s). However, a step input of 1 m/s is prescribed at t=5 s, causing the wind vector to become \vec{W}=[6 1] (m/s). FIG. 11 illustrates a trajectory for 7.7 simulated seconds at a nominal cruising speed of 45 mph (22.1 m/s), with 1 m/s step change in wind X-component at t=5 s.

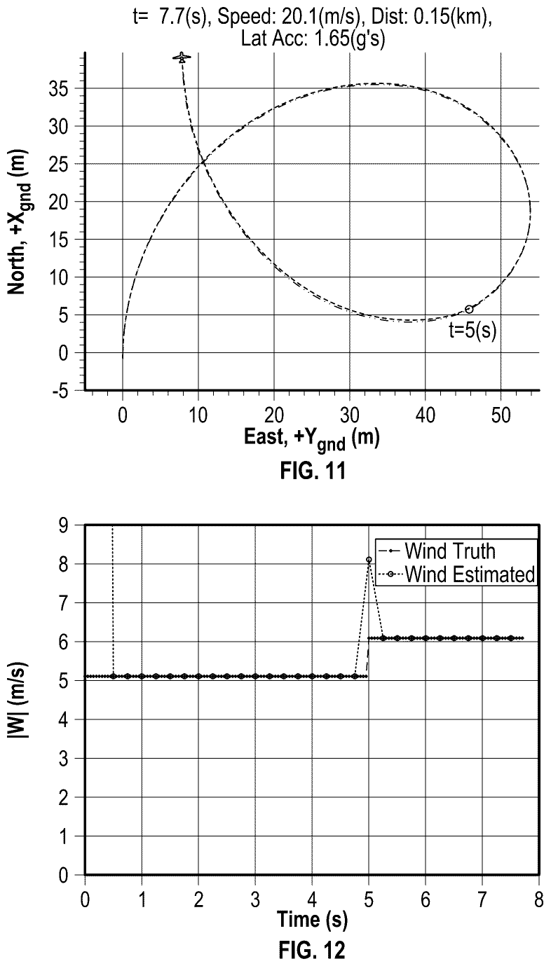

FIG. 12 shows an illustrative example comprising a comparison between idealized and estimated wind magnitudes, based on simulation corresponding to FIG. 11, and showing an error associated with a step input at t=5 s. FIG. 12 compares both the simulated (idealized) and estimated wind vector magnitudes. The two are identical when the constant wind assumption is met, but the step input at t=5 s causes a substantial magnitude error. The estimated wind vector also has a one-step convergence period at t=0 before the well-defined 1-2 point-pairs. FIG. 12 shows Wind-Arc estimates occurring uniformly every 0.25 simulated seconds, which represents a 4 Hz sample rate. Note that this sample rate, in this example, is a state-based trigger resulting from yaw angle changes and not explicitly a function of time.

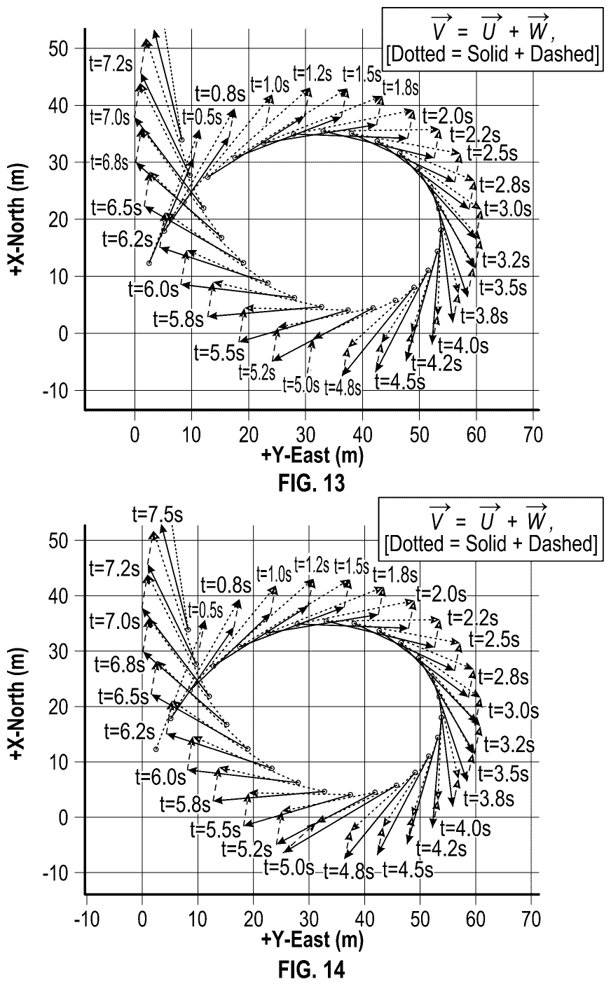

FIG. 13 shows an illustrative example of wind triangles formed using kinematic simulation, with a simulated step input at t=5 s. Generally, FIG. 13 illustrates the idealized wind triangles directly available in the simulation for the same flight. The idealized wind vector at t=5.0 s is properly formed and oriented and almost imperceptibly changes from \vec{W}=[5 1] (m/s) to \vec{W}=[6 1] (m/s) at t=5 s.

FIG. 14 shows an illustrative example of wind triangles formed by simulating a Wind-Arc technique as shown and described herein, with a simulated step input at t=5 s. FIG. 14 illustrates estimated wind triangles for the same maneuver and step input at t=5 s as was used for FIG. 13. A malformed wind triangle results from the 1 m/s step change from \vec{W}=[5 1] (m/s) to \vec{W}=[6 1] (m/s). The poor estimate in FIG. 14 at t=5 s results from unmet constant wind and airspeed assumptions between successive measurement snapshots. A ground speed vector is different, but almost imperceptibly so, when the step input occurs at t=5 s. The airspeed vector, \vec{U}, is visibly larger in magnitude and has a larger orientation change than either airspeed vector before or after the step input. Wind Triangle Error Analysis

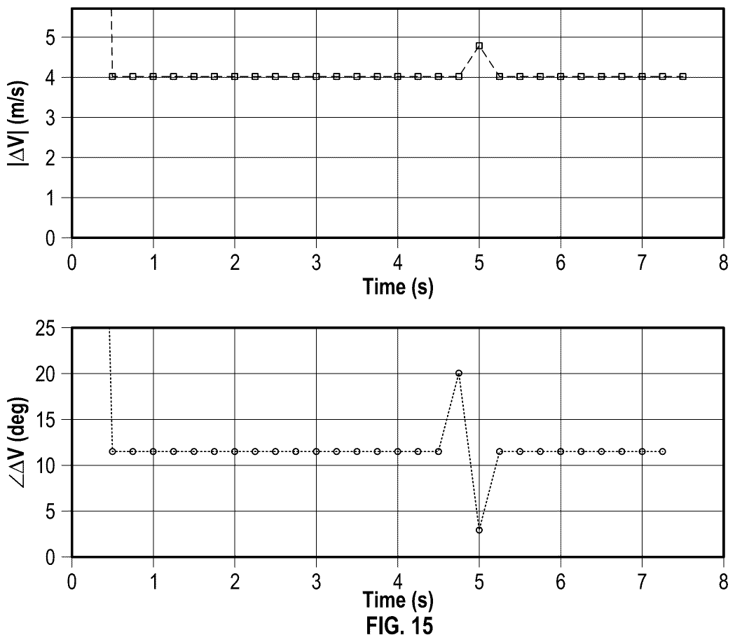

FIG. 15 illustrates magnitude and angle of the wind triangles of FIG. 13, showing at t=5 s, a malformed wind triangle. The airspeed vector can be estimated using Equation (13): \vec{U}₁=N⁻¹·[\vec{V}₂−\vec{V}₁]. To understand which term causes the malformed triangle at the step-change in wind, two terms: N−1 and \vec{ΔV} can be considered. The matrix N, and its inverse will be well behaved because the heading angle change, Δψ, is a predictable value based on the vehicle's captured yaw angles, ψ₁ and ψ₂. Matrix N and its inverse will have a good condition number and be nearly identical before, during, and after the step input. The unexpected change in this example occurs in the ground speed term, \vec{ΔV}=\vec{V}₂−\vec{V}₁. This vector, \vec{ΔV}, represents the tip of one ground speed vector, \vec{V}₁, to the tip of the next subsequent vector ∠\vec{ΔV}. FIG. 15 shows both the magnitude, |\vec{ΔV}|, and sequential heading angle changes, ∠\vec{ΔV}, including both a noticeable magnitude change and also a noticeable orientation change at the t=5 s wind step input. The angle change is initially larger, and then, smaller, before and after the wind step change. This signature, combined with the magnitude change, is an indicator of the method's potential lower-quality estimate when constant wind assumptions are not met.

The examples discussed above illustrate generally that the Wind-Arc technique provides perfect performance during idealized, simulated conditions. The method captures successive heading angle and velocity vectors as the only sensed values to estimate wind direction and magnitude. It also shows results from a 1 m/s step input in the wind vector and presents results when the constant wind assumptions are not met.

Results from Real Flight Tests

The illustrative examples below describe experimental data from two separate vehicles. Real flight data were collected from instrumented aircraft to compare the Wind-Arc technique to the flow sensor approach. First, flight test results from a fixed-wing aircraft, and then, flight test results from a multi-rotor vehicle are shown. Both aircraft are instrumented in order to compare the Wind-Arc technique to the Direct Flow Measurement method. A multi-rotor UA (DJI Matrice 100) was instrumented with an FT-205 (AcuRes) Anemometer that logs a 2D airspeed measurement at 10 Hz. A fixed-wing UA shown used for experimental evaluation was a VTOL Censys Sentaero with a TriSonica Mini ToF Anemometer that logs a 3D airspeed measurement at 10 Hz. Both data acquisition systems are powered and controlled by a Raspberry Pi 3 with an additional Pixhawk v4 Mini specifically installed to provide the vehicle velocities and orientations. This flight controller is an additional payload that was not used to control the aircraft and was used solely for data collection purposes in these illustrative examples. In both vehicles, the anemometer estimates airspeed in the body-fixed frame and vehicle speed using GPS velocity and Course Over Ground (COG). Post-processing is performed to transform the body-fixed airspeed vector into the NED frame, \vec{U}. Then, airspeed was subtracted from ground speed in Equation (1) to estimate wind using \vec{W}=\vec{V}−\vec{U}.

Flight Test #1 with Fixed-Wing Aircraft and Trisonica 3D Sonic Anemometer

This section presents the experimental results from a fixed-wing aircraft flying waypoint-based missions at an airfield near Daytona Beach, Florida. The aircraft flown was a Sentaero Vertical Take-off and Landing (VTOL) aircraft manufactured by Censys Technologies Inc. (Daytona Beach, FL, USA) with a cruise speed of 45 mph.

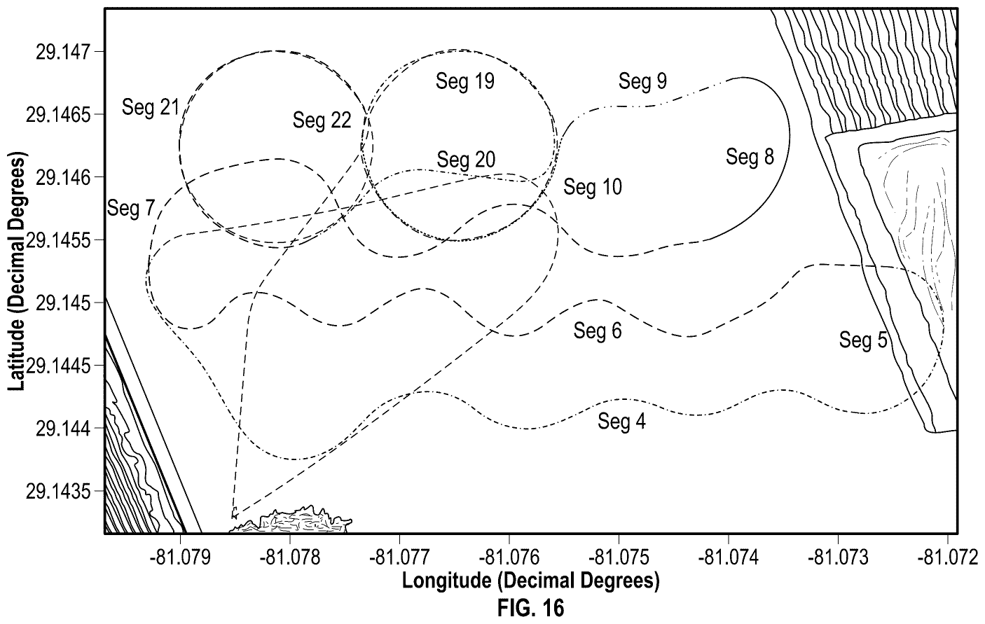

FIG. 16 shows a flight path associated with experimentally-obtained flight trajectory data, where the flight path has been segmented. Take-off and landing are shown on the far left, and the two separate loiter circles include multiple rotations with a constant radius at two different elevations. The vehicle missions were designed using Mission Planner v1.3 software, and then, executed using the on-board Pixhawk4 flight controller to fly the aircraft to each waypoint in automatic navigation mode. The standard take-off and landing maneuvers, plus the loiter circles, were all typical for VTOL flight. But the straight sections had waypoints specifically chosen with alternating lateral offsets to induce both left and right turning for the Wind-Arc technique. FIG. 16 shows segments of the broader flight path as differentiated. These segments were created by selecting points of interest, and then, using a simple algorithm to segment the path into smaller portions for discussion and investigation. The lateral offsets in segments 4, 6, and 7 were designed as zig-zags specifically to exceed the yaw angle change that can trigger the Wind-Arc technique.

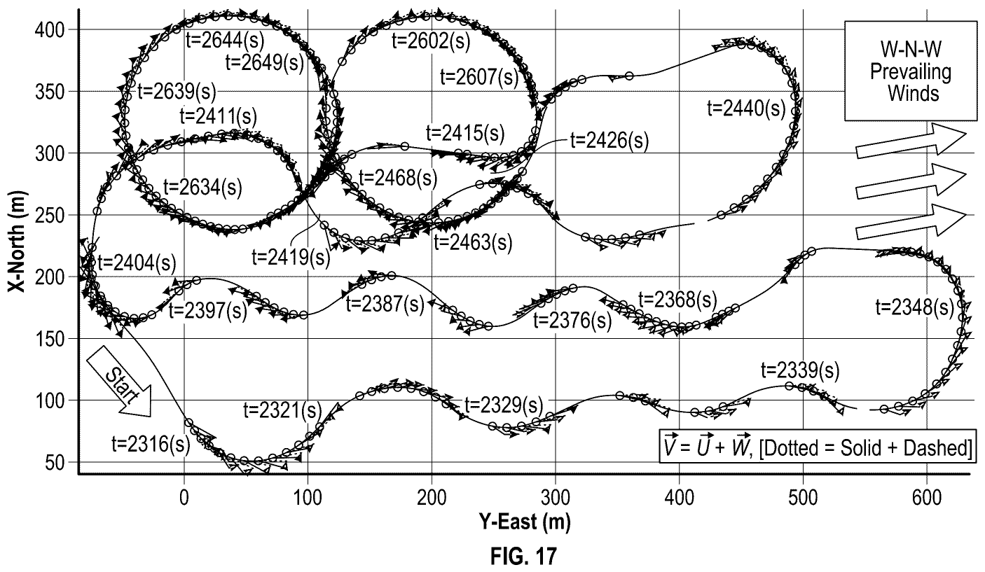

FIG. 17 shows an illustrative example of wind triangles formed by processing the flight trajectory segments shown in FIG. 16. FIG. 17 illustrates that the zig-zag patterns in segments 4, 6, and 7 did, indeed, provide enough yaw angle change to achieve good wind triangles, and thus, good wind estimates. Loiter circles can also provide regular updates while circling. The prevailing winds were west-north-west at 10-15 mph just prior to a summer rainstorm passing through, so some variation in wind speed and direction was expected and observed.

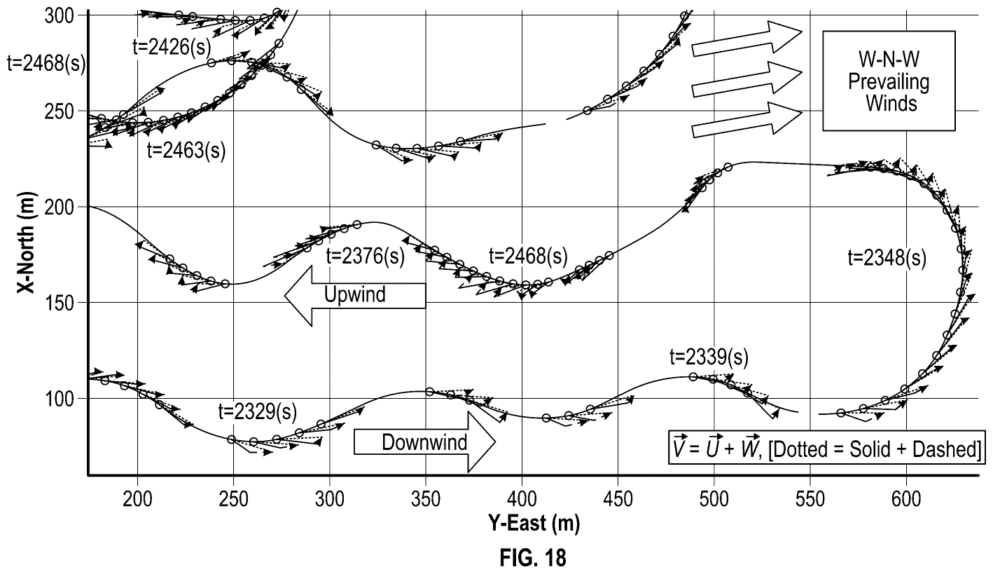

FIG. 18 shows an illustrative example of a more detailed view of a portion of FIG. 17 including segments defined by a zig-zag pattern. FIG. 18 shows a closer view of the wind triangles in segments 4, 5, and 6 and reveals how yaw angle changes result from the zig-zag waypoint patterns. The Wind-Arc approach as formulated herein uses successive rotations in Equation (2) that exceed a threshold, Δψₜₕᵣₑₛₕ. The results are shown using Δψₜₕᵣₑₛₕ=10 deg. When this state-based threshold is exceeded, there are wind estimates, and vice versa. The technique described herein works well when traveling downwind, cross-wind, and upwind. Inspection GPS velocities reveals larger ground speeds when traveling downwind compared to upwind. Airspeed is approximately constant because the vehicle speed command was approximately constant during automatic waypoint flight. This means the airspeed vectors are approximately the same length throughout but the GPS ground speed vector magnitudes change with the direction of travel, as expected.

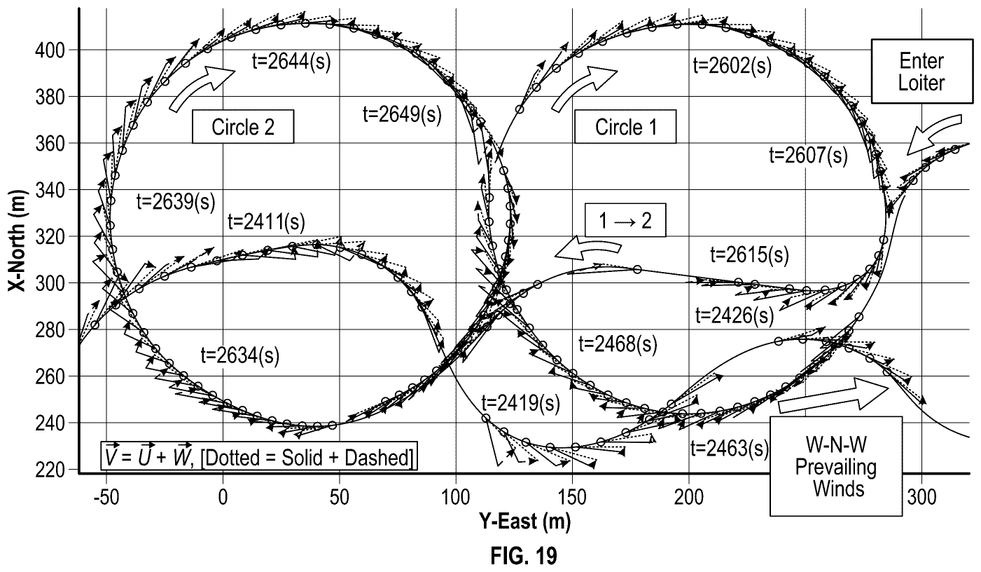

FIG. 19 shows an illustrative example of another detailed view of a portion of FIG. 17 including segments defining loiter circles. FIG. 19 shows a closer view of two loiter circles. Inspection of the GPS velocities illustrates a larger ground speed vector when flying downwind. Only two loiter circles are shown for visual clarity.

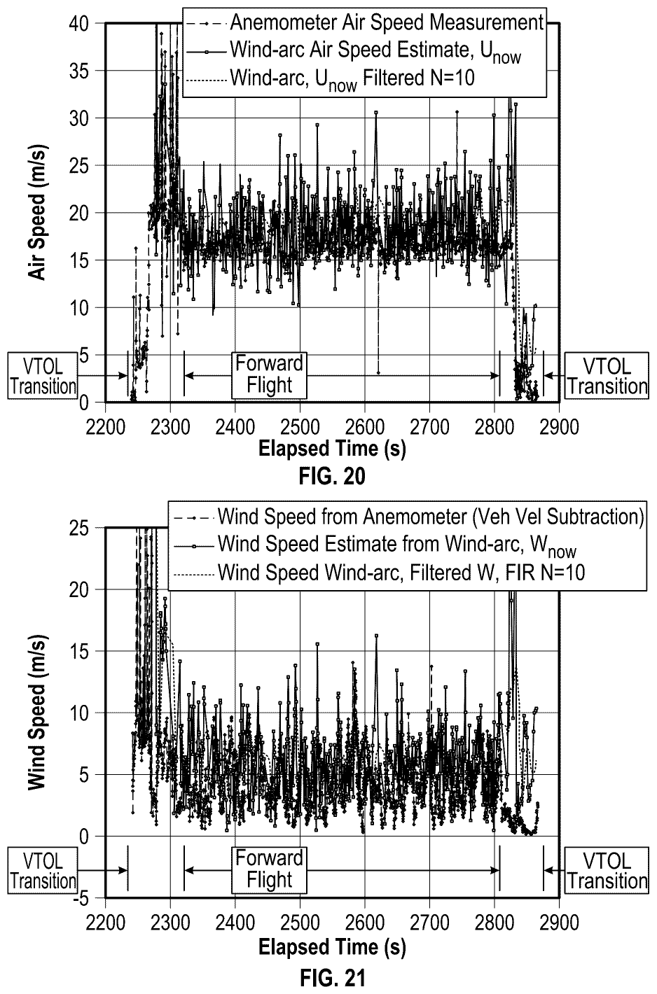

FIG. 20 shows a comparison between measured airspeed and Wind-Arc estimated airspeed. In particular, FIG. 20 shows a comparison between a sonic anemometer's measured airspeed during all segments of FIG. 16, including the VTOL vertical transitions to and from forward flight. The anemometer's measured airspeed is mostly steady during forward flight. The Wind-Arc technique shows very good agreement with the measured anemometer data, with a moving average of the Wind-Arc technique showing a small positive bias relative to the anemometer. Wind-Arc updates occur, on average, every 0.5 (s), which represents a 2 Hz sample rate. Anemometer updates occur at 10 Hz.

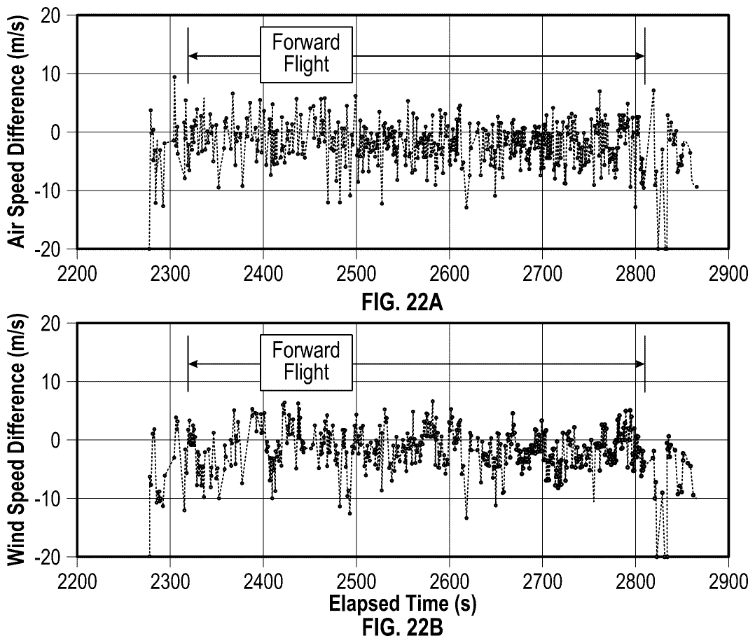

FIG. 21 shows a comparison between anemometer-derived wind speed with vehicle velocity subtracted and Wind-Arc estimated airspeed and FIG. 22A and FIG. 22B show computed differences between flow-sensor-based measurements and Wind-Arc estimated speeds, with airspeed differences shown in FIG. 22A and wind speed differences shown in FIG. 22B. Wind is a difficult quantity to measure, so error is a difficult quantity to estimate. The anemometer method provides the most accurate estimate, but philosophically and practically, there are still errors present. Therefore, what is presented here are the differences between the two estimates. In particular, FIG. 22A shows the difference between measured airspeed for the anemometer-based method versus the Wind-Arc technique, and FIG. 22B and shows the difference between measured wind speed for the anemometer-based method versus the Wind-Arc technique.

Flight Test #2 with Multi-Rotor Aircraft and FT205 2D Sonic Anemometer

This section presents wind estimation using a multi-rotor vehicle flown in such a way as to collect successive positions and orientations suitable for demonstration of the Wind-Arc technique for wind estimation. As discussed elsewhere herein, the Wind-Arc technique can be used for estimation of wind using successive wind triangles after a small rotation, which is encountered during fixed-wing flight. But this sort of rotation is also easily achievable using a multi-rotor aircraft. The Wind-Arc technique may be appealing with multi-rotor operations because of their omnidirectional motion. This capability, plus the difficulty of avoiding rotor wash, make it difficult to incorporate a directional sensor, like a Pitot tube or MHPP, on a multi-rotor UA. For the examples in this section, a 2D sonic anemometer was mounted on a custom mast to avoid sensing rotor-induced air flow. A white solar radiation shield was used to ensure that scalar temperature and humidity sensors measure ambient temperature and relative humidity. The pilot flew the multi-rotor in a manner where yaw motion was coordinated with forward motion, similar to a fixed-wing aircraft. Achieving flight with translational influence from the wind was the goal. The maneuvers were performed using a ‘manual’ flight controller mode, which engaged the flight controller's orientation stability mode but made no attempt to reject lateral, translational motion from wind. Launching from an open field, the pilot performed several extended manual-mode maneuvers while intentionally allowing the vehicle to drift downwind.

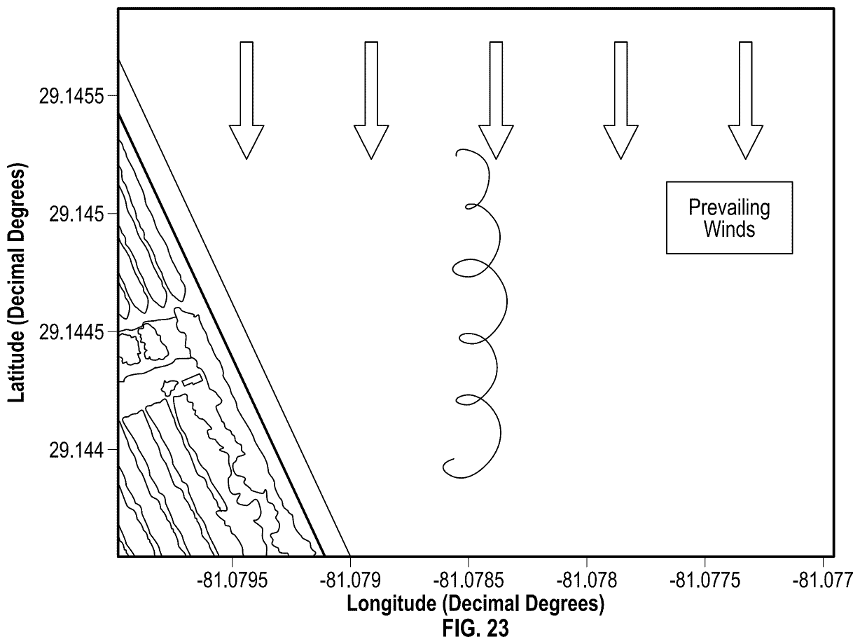

FIG. 23 shows a flight path associated with experimentally-obtained flight trajectory data comprising 65 seconds of constant-yaw-rate turning. The prevailing winds caused the vehicle to translate downwind while turning with a constant radius. Post-processing flight data involved segmenting the entire flight into sub-segments based on location and yaw-rate. One segment within the complete flight record was well suited for use in illustrating the Wind-Arc estimation technique, and FIG. 23 illustrates this sequence of a nearly constant yaw rate resulting in a downwind spiral. The pilot's manual inputs would have achieved a mostly constant radius turn for just over a minute if wind speeds were zero. But fairly constant winds from the north caused the southward spiral pattern shown in FIG. 23.

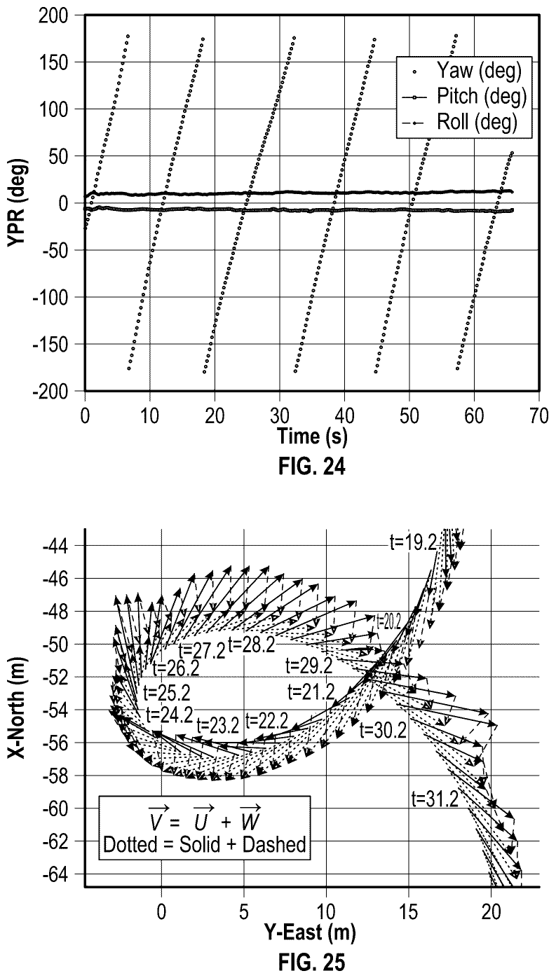

FIG. 24 shows yaw, pitch, and roll parameters corresponding to the 65 s flight trajectory shown in FIG. 23 and performed using manual pilot input. Yaw, pitch, and roll for the approximately 65 s of data recorded are shown in FIG. 24 and illustrate the multi-rotor orientation during five spirals. The trajectory in FIG. 24 mimics fixed-wing motion with coordinated forward motion and associated yawing motion.

FIG. 25 shows wind triangles determined using a Wind-Arc technique between spiral 2 and spiral 3 of the flight path shown in FIG. 23. Applying the Wind-Arc technique to this flight resulted in the wind estimate illustrated in FIG. 25. The velocity vectors are tangent to the flight path, and were directly measured using GPS velocity and Course Over Ground. The Wind-Arc technique estimates the vehicle airspeed, with the airspeed vectors and corresponding wind estimates at each estimation location triggered and determined using Δψₜₕᵣₑₛₕ. The wind vectors vary, but generally point toward the south with a magnitude that could reasonably represent the prevailing winds experienced that day during testing.

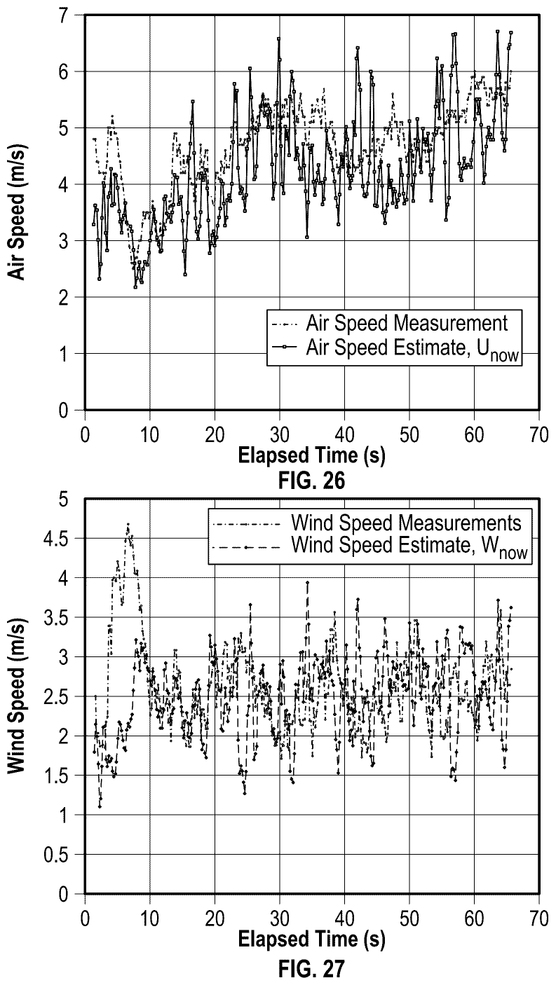

FIG. 26 shows a comparison between anemometer-derived airspeed and Wind-Arc estimated airspeed corresponding to the portion of the flight path shown in FIG. 25. The vehicle's on-board sonic anemometer measured airspeed, which is compared to the estimated airspeed in FIG. 26. Wind-Arc estimates occur, on average, every 0.2 (s) which represents 5 Hz updates. In this example, as in other examples herein, triggering of updates is state-based and not time-based, so the Wind-Arc frequency is a function of yaw rate. The anemometer updates also occur at 5 Hz on the quad-rotor, which is slightly different than the sensor in flight test #1.

FIG. 27 shows a comparison between anemometer-derived wind speed and Wind-Arc estimated wind speed corresponding to the flight path shown in FIG. 23. Wind speed is computed by subtracting (measured) airspeed from vehicle speed, \vec{W}=\vec{V}−\vec{U}. The resulting wind speed is compared to the Wind-Arc estimate as shown in FIG. 27. The Wind-Arc results generally follow the wind speed trend from anemometer-derived results. As mentioned above in relation to flight test #1, wind is a difficult quantity to measure, and both the anemometer-based approach and the Wind-Arc technique exhibit errors that cause them to differ from true wind speed. Philosophically, the true wind speed with no error is not available, so what is shown in FIG. 27 are, in reality, two wind speed estimates, both of which contain some amount of error.

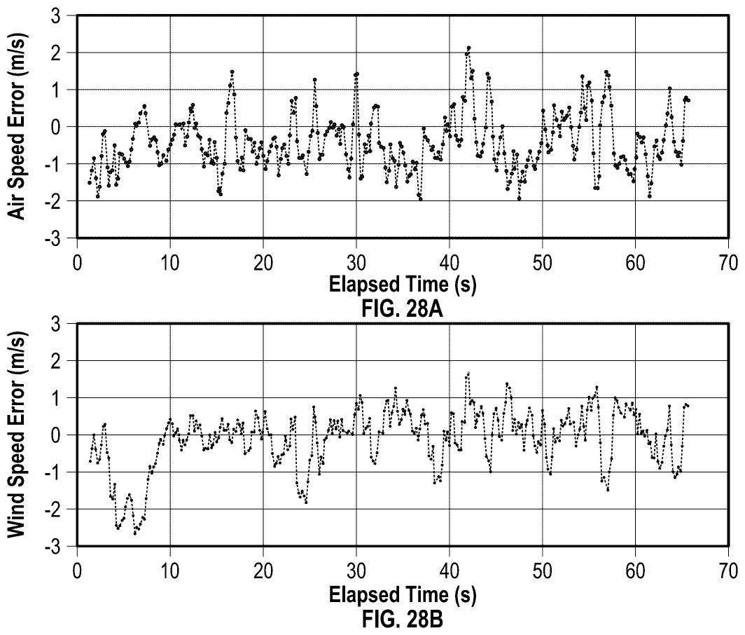

FIG. 28A and FIG. 28B show computed differences between flow-sensor-based measurements and Wind-Arc estimated speeds, with airspeed differences shown in FIG. 28A and wind speed differences shown in FIG. 28B, corresponding to the flight path shown in FIG. 23. Both wind estimates shown in FIG. 27 use GPS velocity and Course Over Ground (COG), but the Wind-Arc technique provides a simpler approach to data collection and processing. Multi-rotor Flight Test #2 appears to have better quality airspeed and wind estimates compared to the fixed-wing experiment in Flight Test #1.

From the simulation and experimental results in this document, several observations can be made.

1. The Wind-Arc technique provides perfect performance both analytically and in simulation under constant wind and ideal sensor conditions. The simulation-based experiments validate the approach, underlying theory, assumptions, and performance. Under real flight tests, the method works well with some moments of unexpected magnitude and direction change.

0.2 Anomalies in the Wind-Arc estimates may be attributable to the following: (a) unmet airspeed or wind speed assumptions, (b) GPS errors, (c) heading or orientation errors, and (d) data logging delays.

3. The anemometer measuring airspeed in both experiments has some variation but is bounded around an average airspeed. This means that airspeed variation was not the dominant source of wind variation. For example, as shown in FIG. 18, the anemometer's airspeed is approximately constant, with the exception of two locations (t= [2450 s, 2625 s]) where the vehicle changed altitude to enter and exit the first loiter circle. This indicates, for this example, the vehicle's forward throttle maintained a nominal airspeed within the surrounding air mass. It also suggests the surrounding air mass moved as a coherent volume such that the entire air mass, with the vehicle, changed ground speed as the wind speed changed regardless of the vehicle's traveling direction (upwind or downwind).

4. One possible source of unexpected anomalous wind estimates is the term [\vec{V}₂−\vec{V}₁] in Equations (14) and (15). GPS velocity is one of the most accurate sources of outdoor horizontal velocity measurements globally, so this term is not the most likely source of unexpected errors. But GPS error may still be worth considering using Horizontal and Vertical Dilution of Precision metrics, or HDOP and VDOP, respectively. These HDOP and VDOP values are embedded in GPS messages and can be recorded and studied to determine the error associated with the [\vec{V}₂−\vec{V}₁] term.

5. Wind-Arc sample rates in examples herein are based on state changes in the yaw angle and were not determined strictly by time. The simulation experiments and both flight tests 1 and 2 showed Wind-Arc estimates at 5 Hz, 2 Hz, and 5 Hz, respectively. This means the Wind-Arc technique, from these experiments, is suited for estimating the lowest average wind speed and may not necessarily be a good candidate for turbulent wind measurement.

6. Wind shear is defined by a velocity gradient across scales in the tens or hundreds of meters. The Wind-Arc technique generally assumes constant wind between two successive snapshots. There is no mathematical requirement for snapshot duration, but practically speaking, a shorter duration will capture the current localized wind conditions compared to a longer duration because the vehicle is moving through the air mass. Snapshot durations of the interval [0.2, 0.5] seconds were presented in two flight tests. At an average airspeed of 20 m/s, these snapshot durations correspond to 4 m to 10 m meters of vehicle travel. Accordingly, the Wind-Arc technique may be suitable for wind shear detection across large enough spatial scales.

Unmet assumptions for constant wind speed may play the largest role in estimation anomalies. The two assumptions are constant airspeed magnitude, |\vec{U}₁=|\vec{U}₂|, and constant wind speed, \vec{W}₁=\vec{W}₂, between two sensor snapshots during turning. From list points 1, 2, and 3 above, it seems the dominant unmet assumption may be changing wind speeds during successive snapshots.

Table 2 shows a comparison between the Wind-Arc technique and methods based on flow sensors and thrust and drag force estimation. The hardware and software complexity of the flow sensor and force estimation methods is comparatively higher than the Wind-Arc technique. The resulting accuracy is also higher than the Wind-Arc technique. What the Wind-Arc technique can provide is a general, platform-independent method for estimating wind with reasonable accuracy and some outliers. The Wind-Arc technique can work with as little as a GPS speed, GPS Course Over Ground, and vehicle heading. This is significantly less complex than either the anemometer or force estimation methods. The Wind-Arc can be used to generate airspeed and wind speed vectors in the NED frame with no need to convert from body-fixed to inertial coordinates. This eliminates the need to log vehicle orientation using Euler angles or Quaternions to transform coordinate frames. Because the Wind-Arc is platform-independent, it is scalable and feasible for widespread use with standard drones. The Wind-Arc technique can be used to profile new air volumes near buildings, trees, bridges, and other critical infrastructure. The Wind-Arc technique means that specialized, highly instrumented vehicles used with anemometer or force estimation methods are not needed to estimate wind with moderate accuracy.

TABLE 2
Wind Estimation Method Comparison

| | Flow Sensor | Thrust and Drag | Wind-Arc |
|---|---|---|---|
| | Methods | Force Methods | Technique |
| Hardware simplicity | Low | Low to Moderate | High |
| and generality | | | |
| Software simplicity | Low | Low | High |
| and generality | | | |
| Scalability, cost | Low | Low | High |
| effectiveness | | | |
| Accuracy for | Moderate to High | Moderate to High | Moderate |
| average wind | | | |

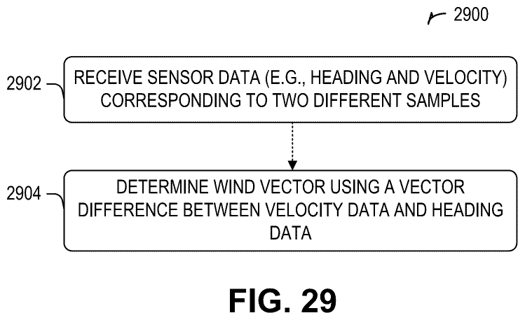

FIG. 29 illustrates generally a technique 2900, such as a machine-implemented method, for performing a portion or an entirety of the Wind-Arc technique shown and described herein. At 2902, sensor data can be received, such as comprising heading and velocity data. Such data can correspond to samples or “snapshots” triggered in response to a heading change exceeding a specified threshold. At 2904, a wind vector (comprising a speed and a wind direction) can be determined, such as by using a vector difference between velocity samples and using the heading data, as shown and described above. The wind vector determined at 2904 can be used for a variety of purposes. A position estimate or a trajectory associated with an aircraft in flight can be updated, such as including compensation for wind effects using a wind vector (corresponding to a wind estimate) determined at 2904. A wind estimate can be used by the same aircraft that acquired the heading and velocity data, or a different aircraft. In an example, a wind field or other data structure can be formed indicative of a series of successive wind estimates, or wind estimates can be performed successively in response to heading changes to provide ongoing wind correction or wind estimate data acquisition.

Generally, the apparatus and techniques described herein can provide a simpler approach to wind estimation as compared to other approaches such as (a) direct flow measurement and (b) drag force estimation. Direct flow measurement is time- and resource-intensive but performs quite well after vehicle velocity subtraction. The drag force estimation method also performs well but is non-trivial and vehicle-specific. The drag force method generally relies on, among other things, modern flight controllers rejecting wind as a disturbance during specified motion. The present subject matter is a fundamentally different approach that leverages influence from the wind during turning maneuvers. Instead of rejecting wind as a disturbance, this third method seeks influence from the wind so GPS velocities and compass headings can be used to solve successive wind triangle equations.

Unlike an aviator's wind drift circle, the present subject matter does not require complete circles. The present subject matter can be performed using small orientation changes, or arcs, that create enough equations to algebraically estimate wind vectors between brief sensor snapshots. Sensors used for the present technique can include GPS and a compass to detect orientation changes. Pitch angle changes may also be used but the examples herein focus on yaw angle changes during turning. A simple method for incorporating the wind triangle into aircraft simulations was also presented. This method is applicable to a broad class of simulated motion under the influence of wind because these velocity and position relationships are common to both kinematic and dynamic vehicle models. Also, simulation provided a method for ensuring the wind triangles were generated and displayed graphically which provides valuable insight into the wind triangle solutions. Distributing the wind triangle solutions graphically along the vehicle trajectory illustrates when the Wind-Arc technique was triggered and under what flight conditions the airspeed and wind speeds were estimated.

The simplicity of the Wind-Arc technique makes it suitable for wind estimation using either drones or crewed aircraft. In particular, the vision of Advanced Air Mobility (AAM), encompassing diverse operations ranging from air taxis to drone delivery, relies on safe operation in the national airspace. This includes flight near buildings and bridges where current wind estimates are limited or nonexistent. This method allows almost any drone to profile winds near critical infrastructure because almost all drones have GPS and a compass. A simple, reliable method for estimating winds near buildings or other obstructions is critical to the future of AAM operations and the Wind-Arc technique shows high potential to meet this need.

In addition to simulation, two experimental flights were presented that showed favorable results with real aircraft flying in real wind conditions. The first instrumented aircraft was a fixed-wing VTOL drone flown with a 3D sonic anemometer mounted on a forward-facing mast to sample undisturbed air. A comparison of both the measured and the estimated airspeeds were presented with the majority of points differing by less than 10 m/s. The wind difference was comparable. This vehicle was flown with typical automatic waypoint control, with some waypoints intentionally placed to induce turning motion to trigger the Wind-Arc technique. Figures comparing both measured and estimated airspeeds and winds were presented. The Wind-Arc generates airspeed and wind estimates that follow the anemometer-based trends. Some wind triangle solutions were made without meeting the constant airspeed and constant wind speed assumptions. A way to detect when, and the degree to which, these assumptions are met is needed to further improve the Wind-Arc estimates. This flight proves that the Wind-Arc technique can use GPS and compass data from a flight controller and estimate the wind trend effectively. Visual inspection of the wind triangles provides valuable insight into each wind triangle estimate to provide clues on (a) the current wind conditions and (b) the quality of the Wind-Arc estimate.

The second flight experiment used an instrumented multi-rotor with a 2D anemometer mounted on a mast, again, to ensure the sensor sampled undisturbed air during flight. The pilot was asked to fly with forward motion coordinated with yaw motion similar to a fixed-wing aircraft. The result was quite effective, with the Wind-Arc technique estimating both airspeed and wind speed. The experimental errors in both airspeed and wind speed were small and clearly followed the anemometer-based trend. Flight Test #2 with the multi-rotor provided smaller airspeed and wind speed differences from anemometer-based estimates compared to Flight Test #1.

In summary, the present subject matter can be used for profiling winds with drones near buildings and critical infrastructure. This capability represents an important missing component for the future of UAM and Advanced Air Mobility. Other implementation aspects could include determination of a Quality-of-Estimate (QoE) metric to quantify the airspeed and wind speed estimates. Body-fixed accelerations that exceed an unrealistic threshold, or abrupt changes in GPS ground speeds or airspeeds are likely candidates for a QoE metric. Also, body roll during turning may have an unexpected influence on the Wind-Arc technique.

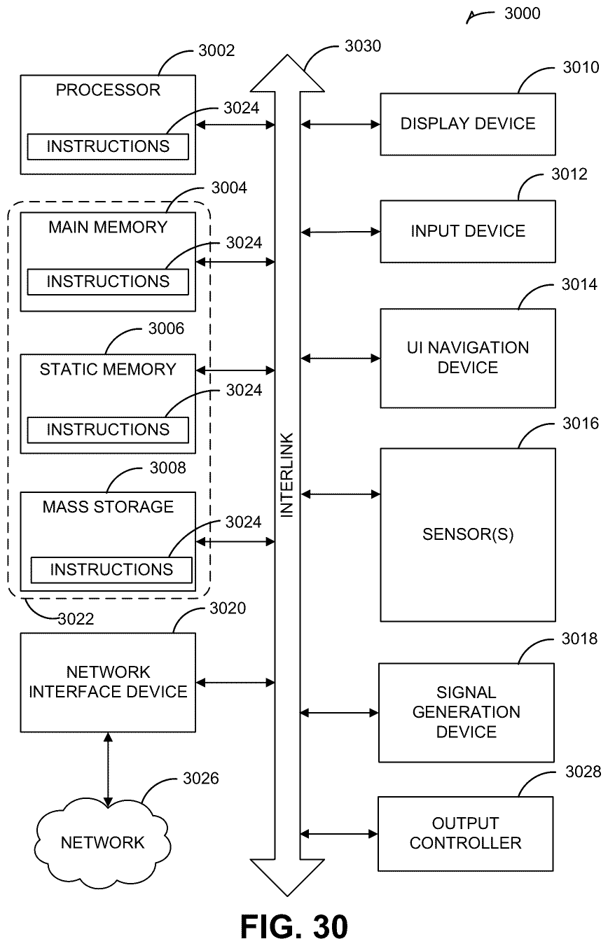

FIG. 30 illustrates a block diagram of an example comprising a machine 3000 upon which any one or more of the techniques (e.g., methodologies) discussed herein may be performed. Machine 3000 (e.g., computer system) may include a hardware processor 3002 (e.g., a central processing unit (CPU), a graphics processing unit (GPU), a hardware processor core, or any combination thereof), a main memory 3004 and a static memory 3006, connected via an interlink 3030 (e.g., link or bus), as some or all of these components may constitute hardware for systems or related implementations discussed above.

Specific examples of main memory 3004 include Random Access Memory (RAM), and semiconductor memory devices, which may include storage locations in semiconductors such as registers. Specific examples of static memory 3006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 3000 may further include a display device 3010, an input device 3012 (e.g., a keyboard), and a user interface (UI) navigation device 3014 (e.g., a mouse). In an example, the display device 3010, input device 3012, and UI navigation device 3014 may be a touch-screen display. The machine 3000 may include a mass storage device 3008 (e.g., drive unit), a signal generation device 3018 (e.g., a speaker), a network interface device 3020, and one or more sensors 3016, such as a global positioning system (GPS) sensor, compass, accelerometer, or some other sensor. The machine 3000 may include an output controller 3028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 3008 may comprise a machine-readable medium 3022 on which is stored one or more sets of data structures or instructions 3024 (e.g., software) embodying or utilized by any one or more of the techniques or functions described herein. The instructions 3024 may also reside, completely or at least partially, within the main memory 3004, within static memory 3006, or within the hardware processor 3002 during execution thereof by the machine 3000. In an example, one or any combination of the hardware processor 3002, the main memory 3004, the static memory 3006, or the mass storage device 3008 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 3024.

An apparatus of the machine 3000 includes one or more of a hardware processor 3002 (e.g., a central processing unit (CPU), a graphics processing unit (GPU), a hardware processor core, or any combination thereof), a main memory 3004 and a static memory 3006, sensors 3016, network interface device 3020, antennas, a display device 3010, an input device 3012, a UI navigation device 3014, a mass storage device 3008, instructions 3024, a signal generation device 3018, or an output controller 3028. The apparatus may be configured to perform one or more of the methods or operations disclosed herein.

The term “machine readable medium” includes, for example, any medium that is capable of storing, encoding, or carrying instructions for execution by the machine 3000 and that cause the machine 3000 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 3024 may be transmitted or received, for example, over a communications network 3026 using a transmission medium via the network interface device 3020 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 3020 includes one or more physical jacks (e.g., Ethernet, coaxial, or other interconnection) or one or more antennas to access the communications network 3026. In an example, the network interface device 3020 includes one or more antennas to wirelessly communicate using at least one of single-input multiple-output (SIMO), multiple-input multiple-output (MIMO), or multiple-input single-output (MISO) techniques. In some examples, the network interface device 3020 wirelessly communicates using Multiple User MIMO techniques. The term “transmission medium” shall be taken to include any intangible medium that is capable of storing, encoding or carrying instructions for execution by the machine 3000, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A machine-implemented method, comprising:
receiving heading data and velocity data corresponding to two different samples associated with an aircraft in flight; and
determining a wind vector using a vector difference between the velocity data corresponding to the two different samples and the heading data; and
storing or transmitting the determined wind vector.

2. The machine-implemented method of claim 1, wherein the velocity data comprises ground speed vectors associated with the two different samples.

3. The machine-implemented method of claim 2, wherein the ground speed vectors are obtained using a Global Navigation Satellite System (GNSS).

4. The machine-implemented method of claim 1, wherein the heading data comprises heading angles associated with the two different samples.

5. The machine-implemented method of claim 4, wherein the heading angles are sensed using an orientation sensor on-board the aircraft.

6. The machine-implemented method of claim 1, comprising obtaining the two different samples, including triggering obtaining a sample amongst the two different samples in response to a change in heading.

7. The machine-implemented method of claim 6, wherein the triggering is in response to the change in head exceeding a specified threshold.

8. The machine-implemented method of claim 1, wherein the determining the wind vector does not require use of an on-board anemometer or flow sensor associated with the aircraft.

9. The machine-implemented method of claim 1, wherein the determining the wind vector includes applying a constraint that wind velocities corresponding to the two different samples are constant.

10. The machine-implemented method of claim 9, wherein the determining the wind vector includes applying a constraint that airspeeds of the aircraft corresponding to the two different samples are constant.

11. The machine-implemented method of claim 1, wherein the aircraft comprises an uncrewed aircraft.

12. The machine-implemented method of claim 11, wherein the aircraft comprises a multi-rotor drone.

13. The machine-implemented method of claim 1, comprising controlling the aircraft using the determined wind vector.

14. The machine-implemented method of claim 1, comprising compiling field data corresponding to a series of wind vector determinations for different spatial locations of the aircraft.

15. A system, comprising:
at least one processor circuit;
at least one memory circuit coupled to the processor circuit, the memory circuit comprising instructions that cause the at least one processor circuit to instantiate a wind estimator, the instructions including:
receiving heading data and velocity data corresponding to two different samples associated with an aircraft in flight;
determining a wind vector using a vector difference between the velocity data corresponding to the two different samples and the heading data; and
storing or transmitting the determined wind vector.

16. The system of claim 15, wherein the wherein the aircraft comprises an uncrewed aircraft.

17. The system of claim 16, wherein the at least one processor circuit and the at least one memory circuit are located on-board the aircraft.

18. The system of claim 15, wherein the aircraft comprises a multi-rotor drone.

19. The system of claim 15, wherein the instructions comprise:
receiving a trajectory plan or other control data; and
controlling the aircraft according using the determined wind vector and the trajectory plan or other control data.

20. A system, comprising:
a means for receiving heading data and velocity data corresponding to two different samples associated with an aircraft in flight;
a means determining a wind vector using a vector difference between the velocity data corresponding to the two different samples and the heading data; and
a means transmitting or storing the determined wind vector.
